(19) United States
(12) Patent Application Publication
(10) Pub. No.: US 2008/0108509 A1
(43) Pub. Date: May 8, 2008

(54) Process for Recognizing Signatures in Complex Gene Expression Profiles

(76) Inventors: Thomas Haupl, Erkner (DE); Joachim Grun, Berlin (DE); Andreas Radbruch, Berlin (DE); Gerd-Rudiger Burmester, Berlin (DE); Christian Kaps, Berlin (DE); Andreas Grutzkau, Berlin (DE)

Correspondence Address: MILLEN, WHITE, ZELANO & BRANIGAN, P.C., 2200 CLARENDON BLVD., SUITE 1400, ARLINGTON, VA, 22201, US

(21) Appl. No.: 11/547,040

(22) PCT Filed: Apr. 4, 2005
(86) PCT No.: PCT/EP05/03520

§ 371 Date: Oct. 1, 2007

(30) Foreign Application Priority Data
Apr. 4, 2004 (DE) 10 2004 016 437.1

(51) Int. Cl. C40B 30/02; G06G 7/48; C40B 60/12

(52) U.S. Cl. 506/8; 703/11; 506/39

(57) ABSTRACT

This invention relates to a process for recognizing signatures in complex gene expression profiles that comprises the steps of: a) making available a biological sample that is to be examined, b) making available at least one suitable expression profile, whereby at least one expression profile comprises one or more markers that are typical exclusively of the expression profile, c) determining the complex expression profile of the biological sample, d) determining the quantitative cellular composition of the biological sample by means of the expression profiles determined in steps b) and c). In addition, the process according to the invention can comprise the steps of e) calculating a virtual signal that is expected based on the specific composition of the expression profile, f) calculation of the difference from the actually measured complex expression profile and the virtual signal, and g) determination of the quantitative composition of the complex expression profile based on the determined differences. In addition, this invention relates to the application of the process according to the invention in the diagnosis, prognosis and/or tracking of a disease. Finally, corresponding computer systems, computer programs, computer-readable data media and laboratory robots or evaluating devices for molecular detection methods are disclosed.

This invention relates to a process for recognizing signatures in complex gene expression profiles, which comprises the steps of: a) making available a biological sample to be examined, b) making available at least one suitable expression profile, whereby at least one expression profile comprises one or more markers that are typical exclusively of the expression profile, c) determining the complex expression profile of the biological sample, d) determining the quantitative cellular composition of the biological sample by means of the expression profiles determined in steps b) and c), e) calculating a virtual signal, which is expected because of the specific composition of the expression profiles, f) calculation of the difference from the actually measured complex expression profile and the virtual signal, and g) determining the quantitative composition of the complex expression profile based on the determined differences. In addition, this invention relates to the application of the process according to the invention in the diagnosis, prognosis and/or monitoring of a disease. Finally, corresponding computer systems, computer programs, computer-readable data media and laboratory robots or evaluating devices for molecular detection methods are disclosed.

### INTRODUCTION

The expression of certain genes at certain times in the life cycle of the cell ultimately determines the phenotype thereof. The analysis of the gene expression in particular in the diagnosis and treatment is of special importance in the case of diseased and/or degenerated cells and ultimately tissues, which can have special, especially complex, i.e., unknown mixtures of expression profiles of different cell types.

The high-throughput processes that are known in the prior art, such as the DNA and protein-array technology, the mass spectrometry or processes in epigenetic studies, allow quantitative determination of complex molecular profiles. With DNA-array examinations, e.g., the activity of genes is measured via the expression of the mRNA.

Also, the protein expression is increasingly available in the high-throughput process via corresponding array technologies or the mass spectrometry. Epigenetic analyses raise profiles to the DNA-methylation state of genes and provide indications regarding the inactivation or the activation capacity of genes. These methods can anticipate extensive developments for molecular diagnosis. There is the hope that various molecular profiles can be associated with special clinical features, diseases can be divided into subgroups by molecular features, and possible interpretations can be developed that supply prognostic data for therapy and the course of the disease. Also, pathomechanisms that make possible a specific therapeutic impact could be derived from the molecular profiles or their interpretation on the level of individual factors.

The samples that are to be examined carry many different molecular data. Numerous genes can be associated in an altered expression both with a shift of the cellular composition of the sample (migration of cells) and an activation of one or more metabolic processes.

The two items of data are found to overlap in the expression pattern or the expression profile. Current bioinformatic analysis methods do not allow any distinction between these two causes. The interpretation of the array data is thus greatly limited. To recognize the gene regulations in cell populations, a purification of the cells is now necessary before the array analysis or a histological study of tissues with immunohistological assignment to cell types. Cell purifications, however, can lead to artificial changes of the gene expression pattern, and histological possibilities are limited to a few genes.

The negative significance of this mingling of cause and effect is all the more impressive as regulated genes do not normally experience any on/off activity, but rather in most cases exhibit a basic activity (constitutive expression). Also, they can be active in different ways in various cell types and also metabolic processes.

Thus, the majority of the differentially expressed genes fall into this group that cannot be definitively identified with regard to cause. Thus, at this time, other studies related to most genes are necessary to clarify whether a shift in the cell composition or a gene regulation has occurred.

Haviv et al. (Haviv, I., Campbell, I. G. DNA Microarrays for Assessing Ovarian Cancer Gene Expression. Mol Cell Endocrinol. 2002 May 31; 191(1):121-6.) describe the simultaneous expression analysis of genes within a given population by means of array technologies. Then, the expression of normal and malignant cells can be compared, and genes are identified that are regulated differently. Vallat et al. (Vallat, L., Magdelenat, H., Merle-Beral, H., Masdehors, P., Potocki de Montalk, G., Davi, F., Kruhoffer, M., Sabatier, L., Omtoft, T. F., Delic, J. The Resistance of B-CLL Cells to DNA Damage-Induced Apoptosis Defined by DNA Microarrays. Blood. 2003 Jun. 1; 101(11):4598-606. Epub 2003 Feb. 13.) describe the comparison of separate B-cell chronic lymphoid leukemia (BCLL) cell samples. In this case, 16 differently-expressed genes are identified, i.a., nuclear orphan receptor TR3, major histocompatibility complex (MHC) Class II glycoprotein HLA-DQA1, mtmr6, c-myc, c-rel, c-IAP1, mat2A and fmod, MIP1a/GOS19-1 homolog, stat1, blk, hsp27, and ech1.

Vasseli et al. (Vasselli, J. R., Shih, J. H., Iyengar, S. R., Maranchie, J., Riss, J., Worrell, R., Torres-Cabala, C., Tabios, R., Mariotti, A., Stearman, R., Merino, M., Walther, M. M., Simon, R., Klausner, R. D., Linehan, W. M. Predicting Survival in Patients with Metastatic Kidney Cancer by Gene-Expression Profiling in the Primary Tumor. Proc Natl Acad Sci USA. 2003 Jun. 10; 100(12):6958-63. Epub 2003 May 30.) describe the analysis of various tissues in the search for potential molecular determinants of tumor biology and possible clinical outcome in kidney cancer. Suzuki et al. (Suzuki, S., Asamoto, M., Tsujimura, K., Shirai, T. Specific Differences in Gene Expression Profile Revealed by cDNA Microarray Analysis of Glutathione S-Transferase Placental Form (GST-P) Immunohistochemically Positive Rat Liver Foci and Surrounding Tissue. Carcinogenesis. 2004 March; 25(3):439-43. Epub 2003 Dec. 4.) describe the gene expression profile in GST-P positive foci in comparison to the surrounding area of the tumor. The GST-P positive foci were cut out by laser and tested by means of cDNA microarray assays.

Favier et al. (Favier, J., Plouin, P. F., Corvol, P., Gasc, J. M. Angiogenesis and Vascular Architecture in Pheochromocytomas: Distinctive Traits in Malignant Tumors. Am J. Pathol. 2002 October; 161(4):1235-46.) describe the study of gene expression profiles within the framework of angiogenesis in tumors.

Pession et al. (Pession, A., Libri, V., Sartini, R., Conforti, R., Magrini, E., Bernardi, L., Fronza, R., Olivotto, E., Prete, A., Tonelli, R., Paolucci, G. Real-Time RT-PCR of Tyrosine Hydroxylase to Detect Bone Marrow Involvement in Advanced Neuroblastoma. Oncol Rep. 2003 March-April; 10(2):357-62.) describe TH mRNA expression as a specific tumor marker and its analysis in various tissues.

Sabek et al. (Sabek, O., Dorak, M. T., Kotb, M., Gaber, A. O., Gaber, L. Quantitative Detection of T-Cell Activation Markers by Real-Time PCR in Renal Transplant Rejection and Correlation with Histopathologic Evaluation. Transplantation. 2002 Sep. 15; 74(5):701-7.) describe a one-step RT-PCR process within the framework of the rejection of transplants that accompany T-cell markers, e.g., granzyme B and perforin.

Finally, Hoffmann et al. (Hoffmann, R., Seidl, T., Dugas, M. Profound Effect of Normalization on Detection of Differentially Expressed Genes in Oligonucleotide Microarray Data Analysis. Genome Biol. 2002 Jun. 14; 3(7):RESEARCH0033.) describe the normalization of array signals by means of three different statistical algorithms for detecting genes expressed in different ways.

Similar analyses are described in, e.g., Schadt, E. E., Li, C., Ellis, B., Wong, W. H. Feature Extraction and Normalization Algorithms for High-Density Oligonucleotide Gene Expression Array Data. J Cell Biochem Suppl. 2001; Suppl 37:120-5; 3: Dozmorov, I., Centola, M. An Associative Analysis of Gene Expression Array Data. Bioinformatics. 2003 Jan. 22; 19(2):204-11; Workman, C., Jensen, L. J., Jarmer, H., Berka, R., Gautier, L., Nielser, H. B., Saxild, H. H., Nielsen, C., Brunak, S., Knudsen, S. A New Non-Linear Normalization Method for Reducing Variability in DNA Microarray Experiments. Genome Biol. 2002 Aug. 30; 3(9): Research0048; Reiner, A., Yekutieli, D., Benjamini, Y. Identifying Differentially Expressed Genes Using False Discovery Rate Controlling Procedures. Bioinformatics. 2003 Feb. 12; 19(3): 368-75; Troyanskaya, O. G., Garber, M. E., Brown, P. O., Botstein, D., Altman, R. B. Nonparametric Methods for Identifying Differentially Expressed Genes in Microarray Data. Bioinformatics. 2002 November; 18(11):1454-61 and Park, P. J., Pagano, M., Bonetti, M. A Nonparametric Scoring Algorithm for Identifying Informative Genes from Microarray Data. Pac Symp Biocomput. 2001: 52-63.

The molecular profiles reproduce various changes that often overlap at the individual measuring points (i.e., a specific mRNA, a protein, a metabolite, the methylation of a specific DNA sequence) and therefore cannot be recognized as partial components from the total value of a measuring point.

This is to be illustrated in the example of the DNA-array analysis. Changes in the gene expression profile can be caused by shifts of the cellular composition of the sample (invasion of cells) and activations of one or more genes. For example, changes in the cellular composition occur in any inflammation and are therefore not specific to a certain disease. However, activations of one or more genes may be typical or even specific to a certain diseases process. Both changes, that of the cellular composition and that of the regulations of genes, are found in hybridization with one another, however, without current bioinformatic analysis methods providing a correlation to the two possible causes. The interpretation of the array data is thus greatly limited.

In a comparable manner to the gene expression, these problems also occur in the imaging of protein expression patterns. If entire tissues are examined, changes in the cellular composition overlap with changes in the protein expression of individual cell types. Comparably, the determination of DNA-methylation conditions, which are distinguished between various cell types, can yield different results in variable cellular composition and can obscure a disease-specific change in an individual cell type. If, however, serum or another bodily fluid is examined, changes that are triggered by a certain disease can be overlaid by other influences, such as a diabetic metabolic position, a renal insufficiency, or a certain therapy, and can hamper an assessment or even make it impossible.

To recognize gene regulations in cell populations, a purification of the cells is now necessary before the array analysis or a histological study of tissues with immunohistological assignment of genes to cell types. Cell purifications can result in artificial alterations of the gene expression patterns, and histological possibilities are limited to a few genes. Also, purification steps are associated with a greater technical expense and thus also a higher cost. The main purpose of a routine application is the examination of samples that are as easily accessible as possible and further processing that is as uncomplicated as possible. For this purpose, blood has the greatest attractiveness of a routine application. In particular, in many diseases, blood is subject in part to considerable fluctuations in the cellular composition and therefore hampers the interpretation of complex molecular profiles of this type of sample.

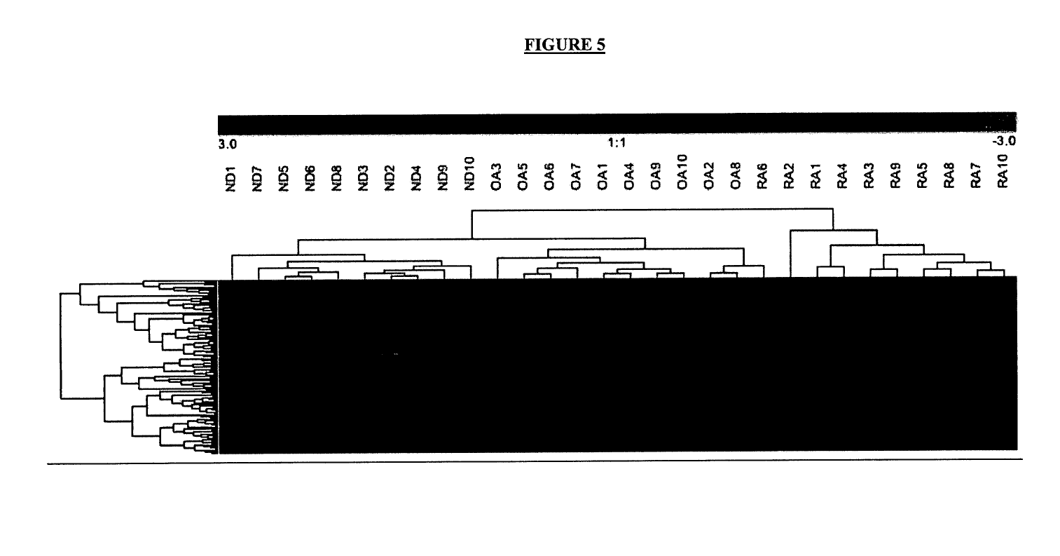

The significance of this mixing of causes and effects is depicted in FIG. 5. This is all the more clear as most regulated genes do not undergo any on/off activity but rather in most cases have a basic activity. Also, they can be active in different ways not only in one cell type but rather in various cell types and also metabolic processes. Thus, the majority of the differentially expressed genes fall into this group that cannot be definitively identified with regard to cause. Thus, at this time, other related studies for most genes are necessary to clarify whether a shift in the cell composition or a gene regulation has occurred.

In principle, this problem is of a more general nature and also applies for profiles of protein expression and protein modification or epigenetic profiles (i.e., different methylation profiles of the DNA that consist of various cell types or complex samples).

It is thus an object of this invention to make available an improved process that can be used to break down the above-mentioned complex data, e.g., from array analyses. The process is to make possible the quick analysis of complex expression profiles that can be applied in high-throughput technology, without special purification steps being necessary. Another object of this invention is to make available a bioinformatic computer program that is suitable for the process according to the invention. Finally, suitable improved devices are to be made available.

One of these objects is achieved according to the invention by a process for quantitative determination and qualitative characterization of a complex expression profile in a biological sample, whereby the process comprises the steps of
a) Making available a biological sample to be examined,
b) Making available at least one suitable expression profile, whereby at least one expression profile comprises one or more markers that are typical exclusively of the expression profile,
c) Determining the complex expression profile of the biological sample, and
d) Determining the quantitative cellular composition of the biological sample by means of the expression profiles determined in steps b) and c).

In a preferred embodiment, the process according to the invention for quantitative determination and qualitative characterization of a complex expression profile in a biological sample comprises the additional steps of
e) Calculation of a virtual signal, which is expected because of the specific composition of the expression profiles,
f) Calculation of the difference from the actually measured complex expression profile and the virtual signal, and
g) Determining the quantitative composition of the complex expression profile based on the determined differences.

This invention indicates a process here that contributes to breaking down complex data from array analyses. This process is structured into several steps according to the invention.

First, the following profiles for separating the effects are required:
a) An expression profile, which represents, for example, the normal state,
b) Other defined or specific expression profiles, which characterize, e.g., defined influences or conditions of a cell or cell population, and
c) The complex expression profile of the biological sample that is to be examined, for example the state of the disease.

The typical “expression profiles” or “profiles” of defined influences and/or conditions are also named “signatures” or “fingerprints” below. For recognizing the cell composition, signatures for the various cell types are necessary, e.g., for monocytes, for T cells, for granulocytes, etc. Comparable to this, a so-called “functional” and/or “characterizing” signature, as it is produced by a certain cytokine action, can also represent a signature in terms of this invention.

For any influence that is to be recognized and separated from other molecular data, marker genes must be defined. The latter can quantitatively assess the proportion of a signature in the overall profile. For recognizing various cellular compositions, e.g., marker genes for monocytes, T cells or granulocytes are thus identified. The latter reflect the proportion of the respective cell population in a mixed sample. For the cellular composition of a sample, other measuring processes, such as, e.g., the differential blood picture or a FACS analysis, also could be used as an alternative.

Different relationships between the molecularly-characterized portion and the portion measured with other methods, which can lead to an incorrect calculation below, can occur, however. The target is therefore to be that the bases for the subsequent calculation come from the same measuring process.

With the aid of the molecular signatures of cell populations (or influences) and their quantitative involvement in the total profile, a virtual signal can be calculated that is expected based on the composition. The difference from the actually measured signal and the expected signal can recognize whether the differences are clarified only by the mixing of the various populations (influences) (no difference), or an activation (positive difference) or a suppression (negative difference) of the gene activity has taken place. As it pertains to all the genes measured with the array, the profiles can be virtually separated into partial components.

On differences in the distribution of the various components, it can be expected that criteria for a division into various groups can be defined. Genes, whose expression properties cannot be supplied to any known partial components, are of special interest for the additional clarification and search for still unknown partial components.

A process according to the invention for quantitative determination and qualitative characterization of a complex expression profile in a biological sample is preferred, whereby the determination of the suitable expression profile comprises the determination of an RNA expression profile, protein-expression profile, protein secretion profile, DNA methylation profile, and/or metabolite profile. Naturally, combinations thereof can also be determined, which hampers the evaluation, however.

More preferred is a process according to the invention for quantitative determination and qualitative characterization of a complex expression profile in a biological sample, whereby the determination of an expression profile comprises a molecular detection method, such as, e.g., a gene array, a protein array, a peptide array and/or a PCR array or the generation of a differential blood picture or a FACS analysis. This invention thus is not limited only to the nucleic acid array. Moreover, expression profiles that consist of gel analyses (e.g., 2D), mass spectrometry and/or enzymatic digestion (nuclease or protease pattern) can also be used.

Still more preferred is a process according to the invention for quantitative determination and qualitative characterization of a complex expression profile in a biological sample, whereby the expression profiles that are determined above in step b) of the process are selected from the group of expression profiles that characterize functional influences or conditions, such as, e.g., expression profiles, that characterize the activity of certain messenger substances, signal transduction or gene regulation. In addition, the latter can characterize the manifestation of certain molecular processes, such as, e.g., apoptosis, cell division, cell differentiation, tissue development, inflammation, infection, tumor genesis, metastasizing, formation of new vessels, invasion, destruction, regeneration, autoimmune reaction, immunocompatibility, wound healing, allergy, poisoning, and/or sepsis. Also, the latter can characterize the manifestation of certain clinical conditions, such as, e.g., the status of the disease or the action of medications. The selection of the expression profiles depends on the origin of the biological sample that is to be examined, as well as its composition and/or expected composition. Optionally, the profiles in the process must be defined in the measurement and be determined as suitable or they can be derived from public expression databases.

Still more preferred is a process according to the invention for quantitative determination and qualitative characterization of a complex expression profile in a biological sample, whereby the calculation of the total concentration is carried out from the proportions Aᵢ of the various cell types or influences (e.g., migrated cell types) i with their different concentrations Kᵢ by means of the relationship

$$\begin{matrix}{K}_{Sample} = {K}_{1} \cdot {A}_{1} + {K}_{2} \cdot {A}_{2} + … \\ = {\sum }_{i = 1}^{n} ( {K}_{i} \cdot {A}_{i} ) with i ∈ N\end{matrix} \qquad ( Equation 3 )$$

Even more preferred is a process according to the invention for quantitative determination and qualitative characterization of a complex expression profile in a biological sample, whereby the SLR value of a marker gene is determined by means of the formula

$${A}_{CellType} = {2}^{\frac{1}{k} ( {SLR}_{Sample / Control} - {SLR}_{CellType / Control} )} \qquad ( Equation 14 )$$

For any influence that is to be recognized and separated from other molecular data, marker genes must be defined. The latter can quantitatively assess the proportion of a signature in the overall profile. For the detection of different cellular compositions, e.g., marker genes for monocytes, T cells or granulocytes are thus identified. The latter reflect the proportion of the respective cell population in a mixed sample.

A process according to the invention for quantitative determination and qualitative characterization of a complex expression profile in a biological sample is preferred, whereby the marker is selected from the markers that are indicated below in Table 2. These markers, however, are only by way of example for the cell types indicated there and can accordingly be determined easily for other tissues by means of the teaching disclosed here.

Further preferred is a process according to the invention for quantitative determination and qualitative characterization of a complex expression profile in a biological sample, comprising the exemplary qualitative and/or quantitative detection of expression profiles of a T-cell, monocyte and/or granulocyte expression profile.

Another aspect of this invention relates to a process for quantitative determination and qualitative characterization of a complex expression profile in a biological sample, whereby the determination of the quantitative composition of the complex expression profile based on the determined differences in addition comprises the identification of a previously unknown expression profile.

The comparison between two complex samples first yields a differential gene expression, which can be produced both by differences in the cellular composition and by gene regulation. In the first step, therefore, the cellular composition can be broken down. This is carried out by using signatures that characterize different cell types. By using normal signatures for tissue and individual cell types, an expected profile that only takes into consideration the normal gene expression is calculated. The difference from this virtual profile and the actually measured profile yields the genes that are altered either by additional cell types that are still not taken into consideration or by regulation. Functional changes in the gene expression are therefore to be expected in this difference. Identification in terms of a specific cell type is not possible at first. These genes, however, stem from the functional change of the cells that are involved. If marker genes are defined for the functional signature that is adjusted by cell type, the proportion of this signature can be assessed quantitatively in the difference between virtual profile and actually measured profile. These functional profiles can now be inferred in steps from the difference between virtual profile and actually measured profile.

Altogether, parameters for the cellular composition and molecular functions are provided that can be correlated with one another as well as with clinical features. As a result, new evaluation scales for the interpretation of array data, which yield a decisive improvement both for the diagnosis and for the identification of therapeutically significant target structures (in particular proteins (e.g., enzymes, receptors) and/or complexes thereof) or regulation mechanisms, are produced.

Another aspect of this invention thus relates to a process for quantitative determination and qualitative characterization of a complex expression profile in a biological sample, whereby the determination of the quantitative composition of the complex expression profile based on the determined differences in addition comprises the identification of molecular candidates for the diagnostic, prognostic and/or therapeutic applications.

Yet another aspect of this invention then relates to a molecular candidate or else a target structure for the diagnostic, prognostic and/or therapeutic application, identified by means of the process according to the invention. Preferred is a molecular candidate for the diagnostic, prognostic, and/or therapeutic application, which has a sequence cited in one of Tables 5 to 8.

According to the invention, the molecular candidates of the invention can in Example a) for characterization of the inflammatory cell infiltration into an inflamed tissue with genes of Table 5 differentiating from gene activation by inflammation, b) for characterization of gene activation in an inflamed tissue with genes of Table 6 differentiating from the cell infiltration, c) for characterization of gene activation or the inflammatory cell infiltration in an inflamed tissue via the calculated portion of activation or infiltration of genes in Table 7 and/or d) for characterization of subgroups of inflammatory gene activation with genes of Tables 6, 7 and/or 8.

Another aspect of this invention then relates to these candidates and/or target structures as “tools” for diagnosis, molecular definition and therapy development of diseases, in particular chronic inflammatory joint diseases and other inflammatory, infectious or tumorous diseases in humans. In this case, the sequences of individual genes, a selection of genes or all genes that are mentioned in Tables 5 to 8 as well as their coded proteins can be used. These tools according to the invention in addition can include gene sequences, which are identical in their sequence to the genes mentioned in Tables 5 to 8 or to their coded proteins or have at least 80% sequence identity in the protein-coding sections. In addition, corresponding (DNA or RNA or amino acid) sequence sections or partial sequences are included, which in their sequence have a sequence identity of at least 80% in the corresponding sections of the above-mentioned genes.

The tools according to the invention can be used in many aspects of prognosis, therapy and/or diagnosis of diseases. Preferred uses are high-throughput processes in the protein-expression analysis (high-resolution, two-dimensional protein-gel electrophoresis, MALDI techniques), high-throughput processes in the protein-spotting technology (protein arrays) in the screening of auto-antibodies as a diagnostic tool for inflammatory joint diseases and other inflammatory, infectious or tumorous diseases in humans, high-throughput processes in the protein-spotting technology (protein arrays) for screening of autoreactive T cells as a diagnostic tool for inflammatory joint diseases and other inflammatory, infectious or tumorous diseases in humans, non-high-throughput processes in the protein-spotting technology for screening autoreactive T cells as a diagnostic tool for inflammatory joint diseases and other inflammatory, infectious or tumorous diseases in humans, or for producing antibodies (also humanized or human), which are specific to the above-mentioned proteins or partial sequences of the tools, which are cited in Tables 5 to 8, or for the analysis in animal experiments or for diagnosis in animals with inflammatory joint diseases and other inflammatory, infectious or tumorous diseases by means of corresponding homologous sequences of another corresponding species.

Other uses relate to the tools as diagnostic tools for detecting genetic changes (mutations) in the above-mentioned genes or their regulation sequences (promoter, enhancer, silencer, specific sequences for the binding of additional regulatory factors).

In addition, the tools according to the invention can be used for therapeutic decision and/or for monitoring the course/monitoring the therapy of inflammatory joint diseases and/or other inflammatory, infectious, or tumorous diseases in humans with use of the above-mentioned genes, DNA sequences or proteins or peptides derived therefrom and/or for development of therapy concepts, which comprise direct or indirect influence of the expression of the above-mentioned gene or gene sequences, the expression of the above-mentioned proteins or protein partial sequences or the direct or indirect influence of autoreactive T cells, directed against the above-mentioned proteins or protein partial sequences, or to use the above-mentioned genes and sequences and their regulation mechanisms with the design and use of interpretation algorithms to be able to detect or to predict therapy concepts, therapy actions, therapy optimizations or disease prognoses.

In addition, the tools according to the invention can be used for influencing the biological action of the proteins derived from the above-mentioned gene sequences, the direct molecular control circuit, in which the above-mentioned genes and the proteins derived therefrom are bonded, and for developing biologically active medications (biologicals) with use of genes, gene sequences, regulation of genes or gene sequences, or with use of proteins, protein sequences, fusion proteins, or with use of antibodies or autoreactive T cells, as mentioned above.

Another aspect of this invention relates to an array as a molecular tool, consisting of various antibodies or molecules with comparable protein-specific binding properties, which are used to detect all or a selection of the proteins that are derived from the genes of Tables 5 to 8 or all or a selection of these proteins. This array can also be present as a kit, e.g., together with conventional contents and directions for use.

Another aspect of this invention ultimately relates to the use of a molecular candidate according to the invention for screening pharmacologically active substances, in particular binding partners. Corresponding processes are well known in the prior art, including, i.a., the following publications: Abagyan, R., Totrov, M. High-Throughput Docking for Lead Generation. Curr Opin Chem Biol. 2001 August; 5(4):375-82. Review. Bertrand, M., Jackson, P., Walther, B. Rapid Assessment of Drug Metabolism in the Drug Discovery Process. Eur J Pharm Sci. 2000 October; 11 Suppl 2:S61-72. Review. Panchagnula, R., Thomas, N. S. Biopharmaceutics and Pharmacokinetics in Drug Research. Int J. Pharm. 2000 May 25; 201(2):131-50. Review. White, R. E. High-Throughput Screening in Drug Metabolism and Pharmacokinetic Support of Drug Discovery. Annu Rev Pharmacol Toxicol. 2000; 40:133-57. Review. Zuhlsdorf, M. T. Relevance of Pheno- and Genotyping in Clinical Drug Development. Int J Clin Pharmacol Ther. 1998 November; 36(11):607-12. Review. Chu, Y. H., Cheng, C. C. Affinity Capillary Electrophoresis in Biomolecular Recognition. Cell Mol Life Sci. 1998 July; 54(7):663-83. Review. Kuhlmann, J. Drug Research: From the Idea to the Product. Int J Clin Pharmacol Ther. 1997 December; 35(12):541-52. Review. J. Hepatol. 1997; 26 Suppl 2:26-36. Review. Shaw I. Receptor-Based Assays in Screening for Biologically Active Substances. Curr Opin Biotechnol. 1992 February; 3(1):55-8. Review. Matula, T. I. Validity of In Vitro Testing. Drug Metab Rev. 1990; 22(6-8):777-87. Review. Bush, K. Screening and Characterization of Enzyme Inhibitors as Drug Candidates. Drug Metab Rev. 1983; 14(4):689-708. Review.

Another aspect of this invention relates to a process for the diagnosis, prognosis and/or monitoring of a disease, comprising a process as mentioned above. The corresponding linkage of the expression profile data with the diagnosis, prognosis and/or monitoring of a disease is known to one skilled in the art from the prior art and can be matched accordingly to the respective ratios (see, e.g., Simon, R. Using DNA Microarrays for Diagnostic and Prognostic Prediction. Expert Rev Mol Diagn. 2003 September; 3(5):587-95. Review.; Franklin, W. A., Carbone, D. P. Molecular Staging and Pharmacogenomics. Clinical Implications: From Lab to Patients and Back. Lung Cancer. 2003 August; 41 Suppl 1:S147-54. Review. Kalow, W. Pharmacogenetics and Personalized Medicine. Fundam Clin Pharmacol. 2002 October; 16(5):337-42. Review; Jain, K. K. Personalized Medicine. Curr Opin Mol Ther. 2002 December; 4(6):548-58. Review.).

Another aspect of this invention then relates to a computer system that is provided with means for executing the process according to the invention. A computer system in terms of this invention can consist of one or more individual computers that can be networked centrally or decentrally to one another. Yet another aspect of this invention relates to a computer program, comprising a programming code, to execute the steps of the process according to the invention, if carried out in a computer. Yet another aspect of this invention ultimately relates to a computer-readable data medium, comprising a computer program according to the invention in the form of a computer-readable programming code.

Yet another aspect of this invention relates to a laboratory robot or evaluating device for molecular detection methods (e.g., a computerized CCD camera evaluation system), comprising a computer system according to the invention and/or a computer program according to the invention. Corresponding devices are well known to one skilled in the art and can be easily matched to this invention.

The invention is now to be further illustrated below based on the attached examples, without being limited thereto. In the attached Figures:

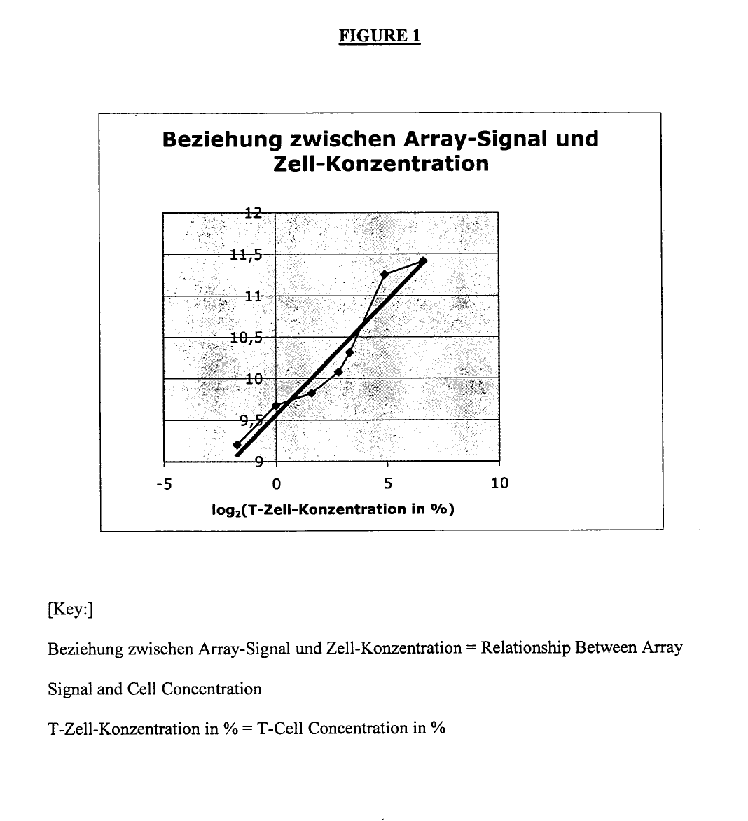

FIG. 1: shows a dilution experiment for assessing the concentration of non-regulated marker genes

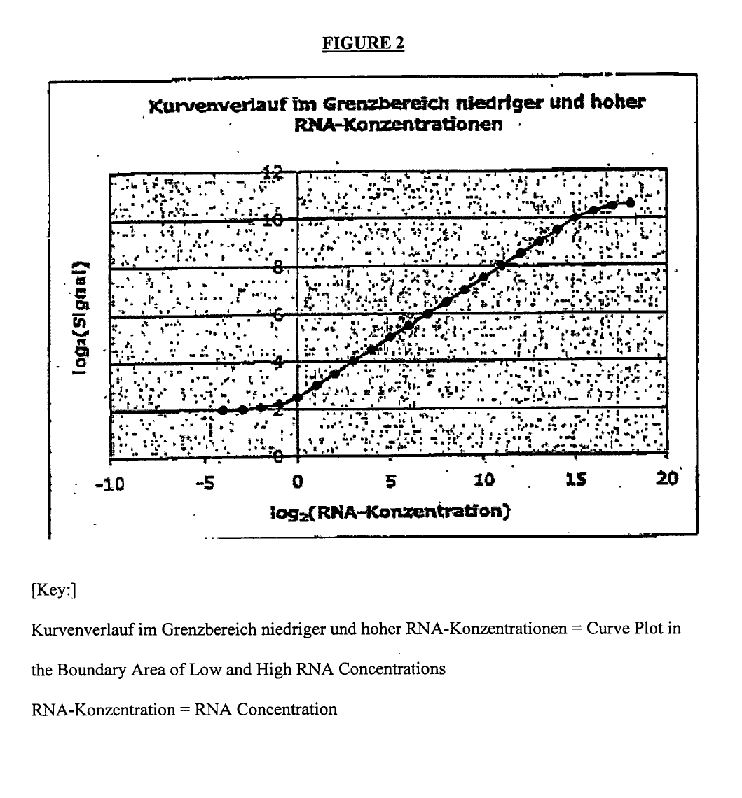

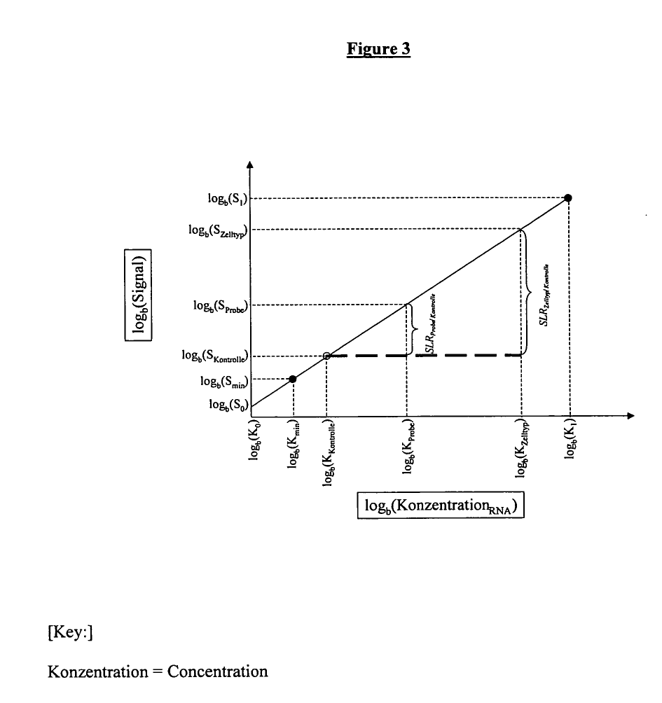

FIG. 2: shows the curve plot in the boundary areas at low and high concentration of the marker

FIG. 3: shows the various relationship values that are used for calculations

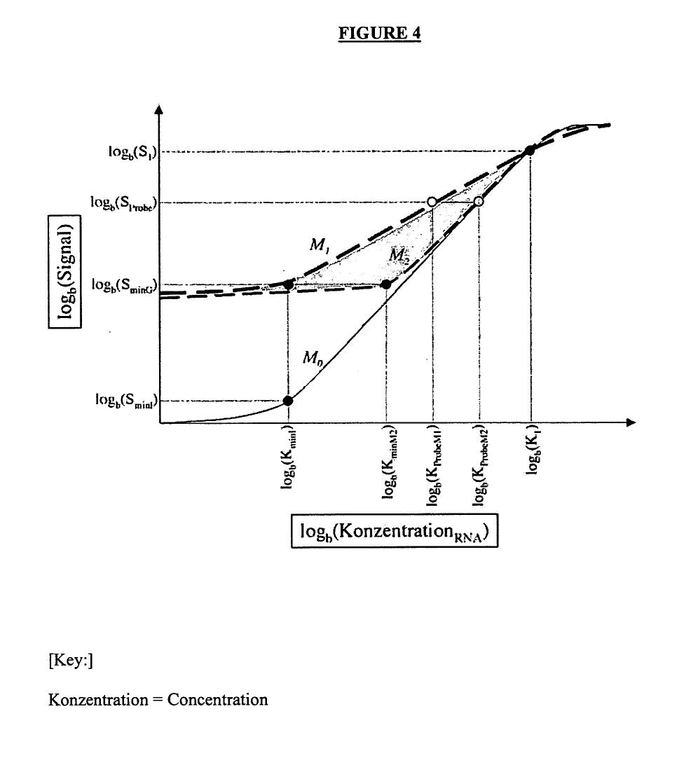

FIG. 4: shows the relationship between signal and concentration under extreme conditions M₁ and M₂

FIG. 5: shows the hierarchical cluster analysis with use of the genes from Table 5

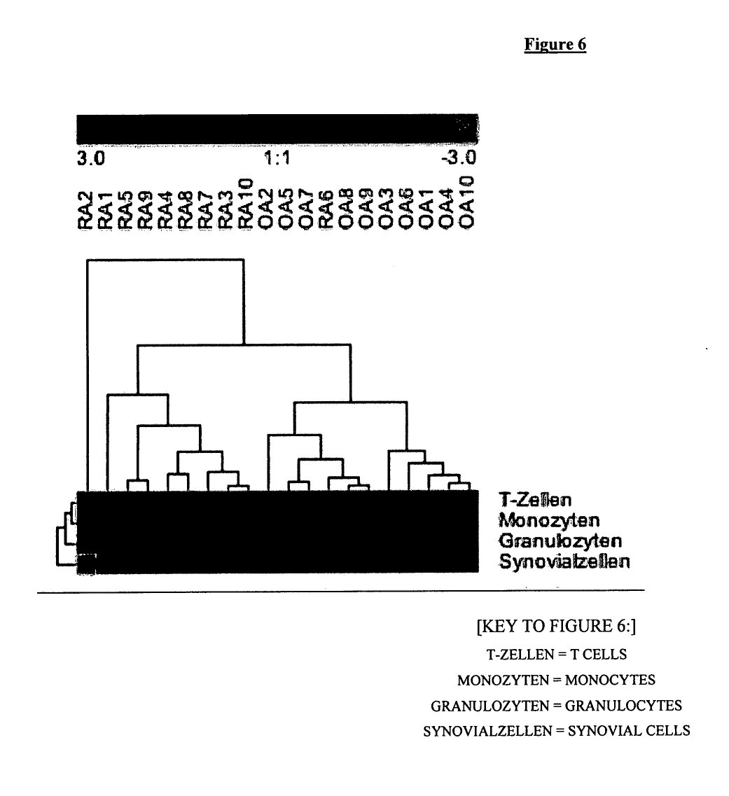

FIG. 6: shows the hierarchical cluster analysis with use of the data from the calculation of infiltration proportions of the various cell types (Table 4)

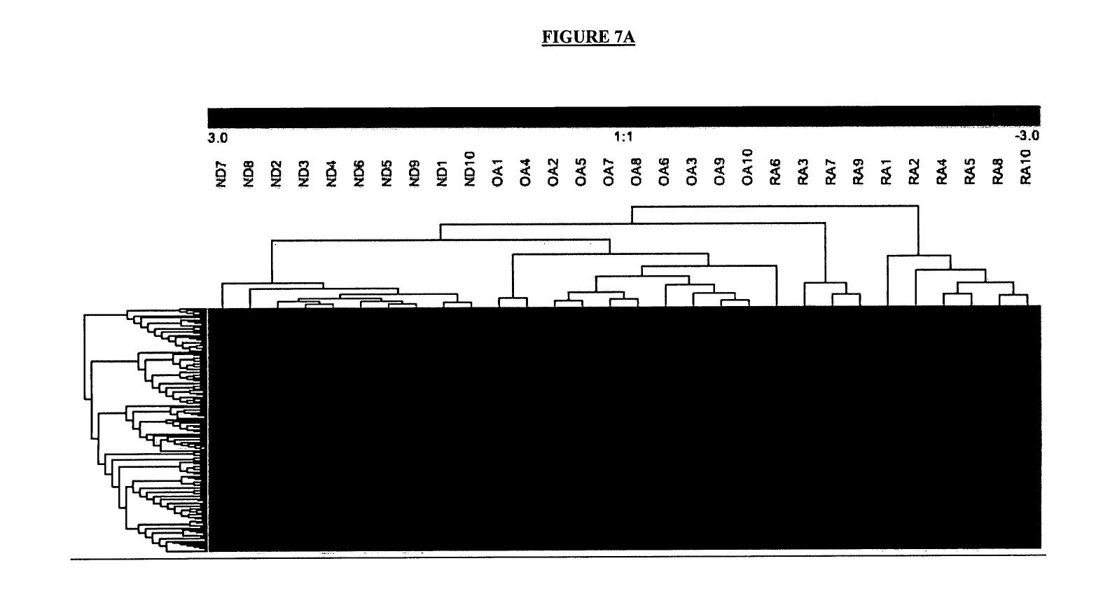

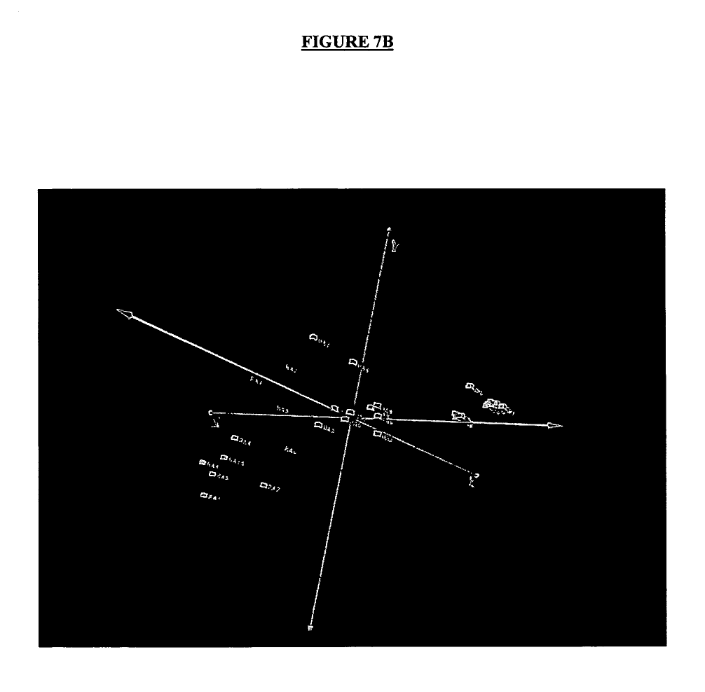

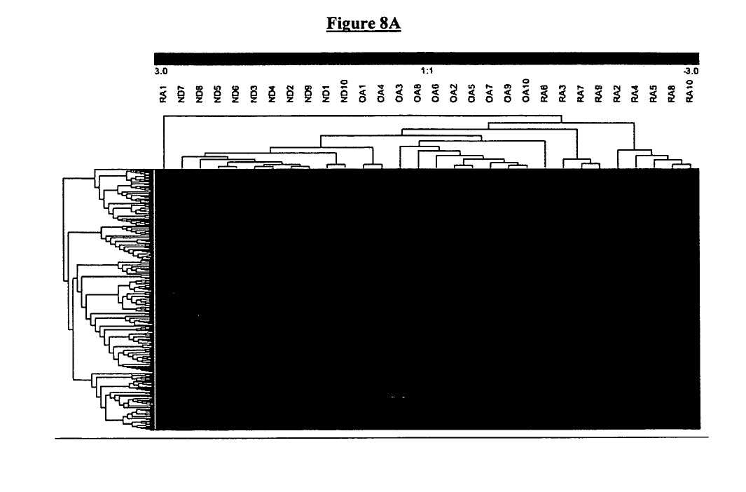

FIG. 7: shows A) hierarchical cluster analysis with use of the genes of Table 6. The representatives RA3, RA6, R7 and RA9 represent a separate group, which is between the OA group and the other RA group, in the hierarchical cluster analysis with Euclidian distance calculation. B) illustration by means of principal component analysis (PCA); genes of Table 6

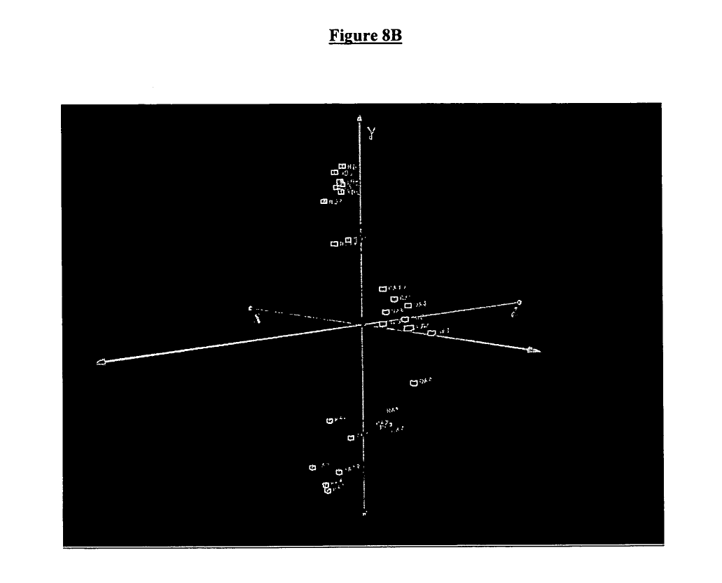

FIG. 8: shows the hierarchical cluster analysis with the genes of Table 7

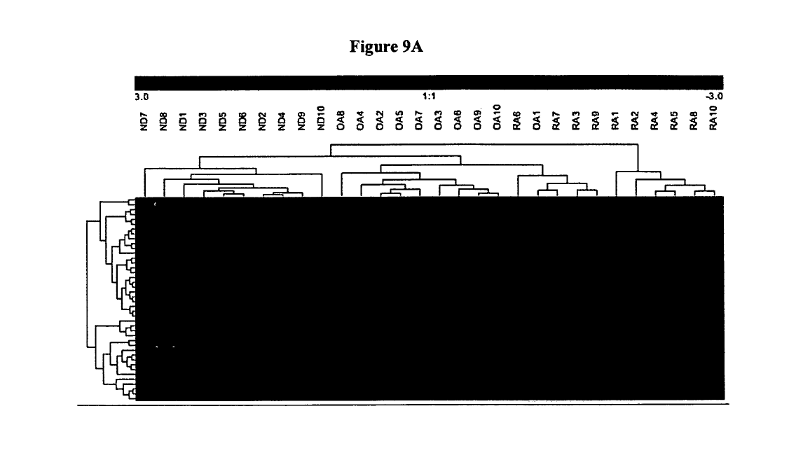

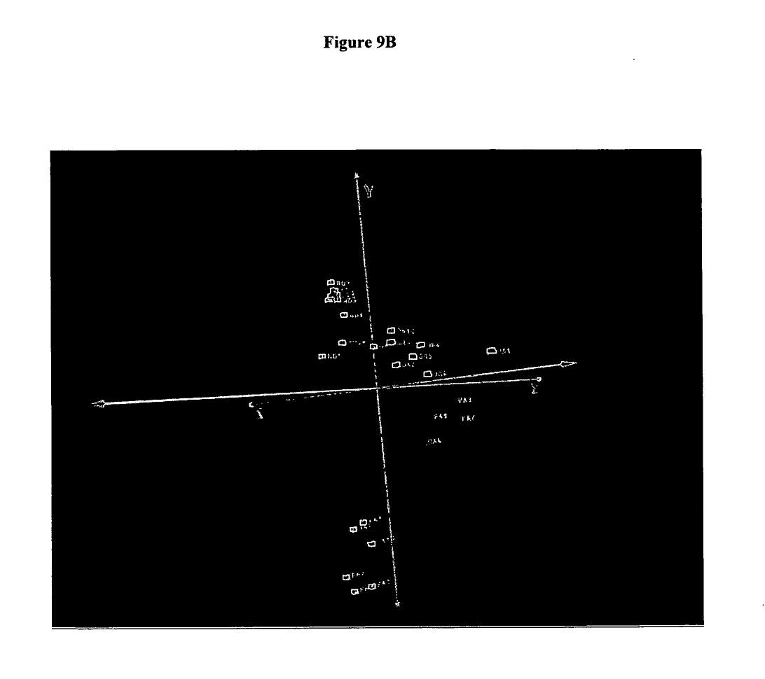

FIG. 9: shows A) the hierarchical cluster analysis with the genes of Table 8. B) the illustration of the differences by means of PCA of the experiments, which are produced by using genes from Table 8.

### EXAMPLES

### Background

The following two different backgrounds may be present:
1.) A cell type (effect to be measured) may be completely lacking in the control sample. In the sample, cells (or effects) that are different and important to the disease are found only in the altered (diseased) state. Example: Synovial tissue in the normal state k has an infiltrate that consists of T cells, monocytes, etc. Only by inflammatory processes do these cells pass into the tissue and experience further activation there.
2.) In contrast, even in the normal situation, a mixture that consists of various cell types (or effects) can already exist. Thus, e.g., the blood from various cells, which undergo variations in the normal state, is assembled. In the case of diseases, these variations can be very strongly pronounced. They are not disease-specific but can possibly obscure the gene regulations that are typical of a disease.

### Settings of the Software That is Used

### Identification of Marker Genes

Different cell types can be distinguished by cell surface markers. Similarly, features that are also different from gene expression analyses that are characteristic of individual cell types and allow a quantitative assessment are also to be expected.

Gene expression profiles of tissues and purified cells were compared to one another. Genes are selected that are present only in one cell population or one tissue, but not in the other. The latter are candidates for the assessment with which proportion this population is present in a sample with mixed cell types.

The cell populations and tissues indicated in Table 1 were compared to one another. The selection criteria for the first stage of the gene selection were that
All measurements in the marker population produce a significantly higher expression than all measurements in other populations and tissues, and
The mean difference between the signals exceeds an extent that, even when a small portion of the overall profile, suggests still measurable differences.

With this selection, the genes indicated in Table 2 were identified. These genes are not suitable for all samples. For example, some of these genes can no longer be detected in the case of low cell concentrations and then result in a quantitative underestimation of the effect. Therefore, additional restriction criteria, which can be matched to the complex samples to be examined, are necessary.
The marker genes must yield adequate signals and differences in the complex sample to be examined if an infiltration/portion of the overall profile has proven its value (e.g., overestimation of the differential blood picture).
In comparison to the control, no regulation of these genes should take place in the sample that is to be examined.
The genes should not be artificially induced or suppressed in the signature profile in comparison to the examined sample.

For the examination of synovial tissues or whole-blood samples, the genes that were separately designated in Table 2 were used. To calculate the proportions, the conditions established in the section below and the assembled equations were used. For selection, the restriction criteria mentioned in Table 3 were used.

Relationship Between Signal and RNA or Cell Concentration

The basic relationship is assumed that the logarithmized values of the measured signal and RNA concentration behave linearly with respect to one another (Equation 1).

log_{b}(y)=k·log_{b}(x)+a (Equation 1)

with y:=signal, x:=concentration of the RNA and bεR.

The practical applicability was examined in a dilution experiment with various concentrations of CD4-positive T cells in CD4-depleted peripheral mononuclear blood cells. For non-regulated genes that occur exclusively in one population, the concentration of this population represents a “concentration unit” for the gene. Thus, the logarithm of the concentration of the CD4-positive cells behaves linearly with respect to the logarithm of the signal. This approximation is illustrated in FIG. 1 in the dilution experiment.

The following theoretical relationships follow from this model assumption:
As a concentration of 0 is approached, the logarithm tends toward −∞.
As the signals approach 0, the logarithm of the signals also tends toward −∞.

In reality, however, other boundary conditions are produced. In the case of low concentrations of a gene, the detection limit is achieved. Low signals of the specifically binding samples are overlaid by signals that consist of improper hybridizations and background intensities. Thus, it results in a smoothing, as it is shown in FIG. 2. This transition proves in practice to be very diverse. If a linear relationship is assumed for this boundary area, excessive values for the concentration of the gene in a sample are mistakenly produced.

Moreover, the hybridization strength, and thus the increase of the signal, is followed by the increase of the concentration for each sequence of an individual dynamic. The latter is determined from the sequence of the sample, but also by the hybridization conditions, the hybridization period and the stringency conditions of the subsequent washing steps.

Also, in high signal areas, the hybridization and detection conditions no longer behave linearly but rather approach a maximum of the measuring system. In this area, the true concentration of a gene is underestimated (FIG. 2).

The actual concentrations of a gene in a given sample are unknown. Theoretically, they can only be assessed from the array hybridization if a corresponding calibration curve for each gene were present. These calibration curves are not present, however, and are also too expensive to create them for all genes. For the comparison of two arrays, first the knowledge of the concentrations is also insignificant. Only the coordination of the arrays with one another by normalizing the signals is important.

FIG. 3 illustrates the various relationship values that are used for calculations.

The following relationship is produced from Equation 1 for determining differences between two arrays A and B:

$${log}_{b} ( {S}_{A} ) - {log}_{b} ( {S}_{B} ) = [ k \cdot {log}_{b} ( {K}_{A} ) + a ] - [ k \cdot {log}_{b} ( {K}_{B} ) + a ] \\ or combined \\ {log}_{b} ( \frac{{S}_{A}}{{S}_{B}} ) = k \cdot {log}_{b} ( \frac{{K}_{A}}{{K}_{B}} ) \qquad ( Equation 2 )$$

Thus, the determination of the difference between the logarithmized values of the signals S_{A} and S_{B}, which also is named signal log ratio, is a measure of the differences between the concentrations K_{A} and K_{B} in the two samples A and B.

For the calculation of the total concentration from the proportions Aᵢ of the various cell types or influences i with their varying concentrations Kᵢ, the following relationship is produced:

$$\begin{matrix}{K}_{sample} = {K}_{1} \cdot {A}_{1} + {K}_{2} \cdot {A}_{2} + … \\ = {\sum }_{i = 1}^{n} ( {K}_{i} \cdot {A}_{i} ) with i ∈ N\end{matrix} \qquad ( Equation 3 )$$

It thus is evident that for the breaking down of the overall profile into individual components, the determination of absolute reference values for the RNA or cell concentration is necessary.

### Assessment of the Detection Limits and the Dynamic Range of the Array

From Equations 1 to 3 and the considerations regarding FIG. 2, the following unknown values that are necessary for the calculation are produced:
The increase k as an expression of the dynamics of the measuring area for a gene, and
The assignment of a defined signal value to a defined concentration for the determination of the straight lines in the coordinate system.

As an attachment point for the determination of straight lines in the coordinate system, the lower detection limit Sₘᵢₙ is selected. The detection limit can theoretically be determined for any gene by dilution experiments. As an alternative, an improper hybridization with sequences that are not completely identical (mismatch oligonucleotides) can be measured for assessment. The Affymetrix technology uses this perfect match/mismatch technology and calculates therefrom a probability as to whether the measured signal of a gene is present or absent.

To determine Sₘᵢₙ for each gene individually, 123 measurements were analyzed with Affymetrix HG-U133A arrays of various cell types, cell mixtures and tissue samples. The maximum and minimum values for each measured gene were determined. At the same time, the presence of these genes was examined. Three groups were produced from a total of 22283 Affymetrix “sample sets” of this array:
1.) 4231 Sample sets, which were classified as “absent” in all 123 measurements,
2.) 2197 Sample sets, which yielded only the “present” status, and
3.) 15855 Sample sets, which were classified partially with “present” and partially with “absent.”

The genes, which were only found to be absent, obviously do not play any role in the measured samples and must not be considered in more detail in the calculation. Should these genes be detectable in other types of samples, the calculation can take place analogously to the 3^{rd} group. For genes that are classified exclusively as “present,” a detection limit can only be estimated. As a measure, the median or mean of all detection limits that were defined for the 3^{rd} group can be used.

The signal height Sₘᵢₙ as a limit of the transition from “absent” to “present” was also determined individually from the 123 measurements for each gene. First, the lowest “present” signals and highest “absent” signals were determined. The median was defined as the limit Sₘᵢₙ from all values lying between these limits. In the case of deficient overlapping, the maximum “absent” value was determined to be Sₘᵢₙ. For all genes that do not have any “absent” determinations, the median of all Sₘᵢₙ boundary values was determined to be a uniform Sₘᵢₙ (68, 6). As an alternative, another form of the assessment such as the mean or a weighted mean could also be used.

The assessment of the dynamic range can be assessed as follows from the measured signal values of a number of various experiments with different samples:

Sᵢ can be defined as the maximum measured value in a series of experiments independently of the gene as an upper limit of the measuring spectrum.

Sₒ can be defined as the minimum reliable measured value of this series of experiments independently of the genes.

The signal log ratio then is produced as

$${log}_{b} \frac{{S}_{1}}{{S}_{0}} \qquad ( Equation 4 )$$

In the example used here, the maximum signal was determined from the 123 measurements with Sᵢ=31581.5 arbitrary units; AU) and the minimum signal was determined with Sₒ=1.2 AU, independently of an individual gene via all genes.

The signal log ratio thus is calculated with use of b=2 for the basis of the logarithm as follows:

$${log}_{2} \frac{{S}_{1}}{{S}_{0}} = {log}_{2} ( \frac{31581 , 5}{1 , 2} ) \approx 14 , 7$$

$$\begin{matrix}[ 31581.5 ] & [ 14.7 ] \\ [ 1.2 ] & \end{matrix}$$

For comparison, the difference between the maximum signal and minimum signal, with consideration of each gene per se, produced a signal log ratio of 15.4. If only “present” signals were included and each gene was considered per se, the maximum signal log ratio was 10.5. All absolute numerical values for signal values depend on the setting of normalization values in the respective software packet for the reading and comparison of DNA arrays. It is not the setting to specific normalization values—and thus the numerical values mentioned here—that is decisive, but rather the uniform use of the same setting for all array analyses that are required for the calculation. With the setting to other normalization values, thus other numerical values are produced that accordingly are to determine the above-mentioned selection conditions. The uniform application is then decisive.

The value from Equation 4 was determined in the Example depicted here to be a theoretical measure for the maximum dynamic range of the signals. For the target relative calculations, the exact values for both scales are not decisive. The signal units are arbitrarily determined in any array platform. Also, the concentration units can be determined arbitrarily. The relative relationships between the signals and concentrations as well as the determination of the detection limits are decisive. Also, in the case of a gene for all various cell types and samples, the same relationship must hold true to execute calculations between the various samples and signatures. The application of similar dimensional ratios for the relationship between concentration and signal in all the different genes makes it possible to transfer roughly the proportion of a signature from one gene to another gene. Here, the agreement is made that for the concentration area, an order of magnitude comparable to the signal range is assigned.

For the relationship between signal and concentration, the extreme conditions M₁ and M₂ shown in FIG. 4 are produced. They show the two boundary areas, how the relationship between concentration and signal can influence the model based on the detection limits.

In this case, Mₒ shows the plot under optimal conditions. In this ideal case, even in the case of very low signals S_{minI}, a linear relationship to the minimum concentration K_{minI} exists. For many genes, the analysis of the hybridization, however, yields a relatively high entry signal S_{minG}, via which the presence of a gene is reliably indicated and from which a linear relationship must be assumed.

In model Mᵢ, the assumption is that a background activity does not significantly impair the detection limits K_{minI} of a gene. Only the detection area of the signal is reduced, and thus the dynamic of the signal increase is reduced. In model M₂, the assumption is that low concentrations remain concealed by the high background and a gene can be detected only starting from a higher concentration K_{minM2}. FIG. 4 illustrates the effects on the concentration determinations K_{sampleM1} or K_{sampleM2} based on the selection of the model M₁ or M₂.

In model M₁, the signal value Sₘᵢₙ is individually calculated for each gene, and a minimum concentration Kₘᵢₙ is assigned to the latter. In this case, K_{min<}K₁ must hold true. For practical reasons, here Kₘᵢₙ₌1 was assigned. K₁ is assigned to the maximum measured signal value S₁. For practical reasons, a concentration of K₁=2^{14.7} that is comparable to the signal measuring area was assigned. The slope of the straight line follows via Equation 1 for each gene individually as follows:

$$k = \frac{{log}_{b} ( {S}_{1} ) - {log}_{b} ( {S}_{min} )}{{log}_{b} ( {K}_{1} ) - {log}_{b} ( {K}_{min} )} \qquad ( Equation 5 )$$

In the model M₂, K_{minI}=1 and thus K_{minM2} is considerably greater than Kₘᵢₙ₁. The slope of the straight lines is produced from the best measured detection limits Kmin1=1 and Sₘᵢₙ₁=1.2, regarded here as ideal, as well as the related maximum values S₁=31581.5 and K₁=2^{14,7} as follows:

$$k = \frac{{log}_{2} ( {S}_{1} ) - {log}_{2} ( {S}_{min 1} )}{{log}_{2} ( {K}_{1} ) - {log}_{2} ( {K}_{min 1} )} = \frac{14 , 7}{14 , 7} = 1 \\ [ 14.7 ] \qquad ( Equation 6 )$$

In both models, signal values under the detection limits cannot be assigned to any definite concentration values. The possible fluctuation range of the relationship between signal and concentration is in the gray underlying area of FIG. 4. Theoretically, a specific relationship equation could be set up via expensive dilution series for each gene individually. The latter must then also be examined for each type of sample and newly filed again in further developments of the array. At this time, such data are not available. Calculations are therefore done based on both models M₁ and M₂, and the results are compared to one another.

In summary, the relationship

$${log}_{b} ( {S}_{sample} ) = \frac{{log}_{b} ( {S}_{1} ) - {log}_{b} ( {S}_{min} )}{{log}_{b} ( {K}_{1} ) - {log}_{b} ( {K}_{min} )} \cdot {log}_{b} ( {K}_{sample} ) + {log}_{b} ( {S}_{min} ) \qquad ( Equation 7 )$$

is now produced with use of Equation 1 for the model M₁,

and the relationship

log_{b}(S_{Sample})=log_{b}(K_{Sample})+log_{b}(Sₘᵢₙ₁) (Equation 8)

is produced for the model M₂ with use of the reference values, used in Equation 6, between signal and concentration.

### Quantitative Assessment of the Proportions of a Cell Population in a Sample with Different Cell Types

The depicted bases for calculation can be used first in the marker genes for individual cell types. For the genes mentioned in Tables 2A to C, this produces the Sₘᵢₙ values mentioned in Tables 2A to C.

From Equations 7 and 8, the RNA concentration for a marker gene can be derived in a measured sample as follows:

### Model M₁:

$${K}_{sample} = {b}^{[ {log}_{b} ( {S}_{Sample} ) - {log}_{b} ( {S}_{min} ) ] \cdot \frac{{log}_{b} ( {K}_{1} ) - {log}_{b} ( {K}_{min} )}{{log}_{b} ( {S}_{1} ) - {log}_{b} ( {S}_{min} )}} \\ or \\ {K}_{CellType} = {b}^{[ {log}_{b} ( {S}_{CellType} ) - {log}_{b} ( {S}_{min} ) ] \cdot \frac{{log}_{b} ( {K}_{1} ) - {log}_{b} ( {K}_{min} )}{{log}_{b} ( {S}_{1} ) - {log}_{b} ( {S}_{min} )}} \qquad [ Equation 9 ]$$

Model M₂ with use of the reference values, used in Equation 6, between signal and concentration:

K_{Sample}=b^{└log}^{_{b}}^{(S}^{_{Sample}}^{)-log}^{_{b}}^{(S}^{ₘᵢₙ₁}^{)┘} or K_{CellType}=b^{└log}^{_{b}}^{(S}^{_{CellType}}^{)-log}^{_{b}}^{(S}^{ₘᵢₙ₁}^{)┘} (Equation 10)

A marker gene for a specific cell type was defined such that in the other cell or tissue types, it cannot be found or is negligibly small. Thus, the following calculation is produced:

A_{CellType}·K_{CellType}+A_{Control}·K_{Control}=K_{Sample}

Since the proportion of the cell population and the concentration of the marker gene in the control tends toward zero (A_{Control}<0.01, S_{Control}<Sₘᵢₙ and thus K_{Control}<1), the following is produced for the proportion of the cell type in a mixed sample:

$${A}_{CellType} = \frac{{K}_{Sample}}{{K}_{CellType}} \qquad ( Equation 11 )$$

For the calculation of the concentrations, various starting data are available. Numerous platforms and software packets yield normalized signal values with which additional calculations can be executed. For this purpose, the above-mentioned equations can be applied directly.

The Affymetrix Technology occupies a special position. In this platform, several different oligonucleotides per gene and related “mismatch” oligonucleotides are used. Also here, signals for immediate additional calculation can be generated (e.g., via the robust multiarray analysis; RMA). Both signal determination and comparisons can also be executed via special algorithms, however, which relate to both perfect match data and mismatch data. The results from the comparison calculation are also indicated as a signal log ratio (SLR) and can be integrated in the calculations executed here. Also, in this way, a reference population can be used as a norm. This is illustrated in FIG. 3. This reference value is named Control. For the example of the synovial tissue analysis, the latter is normal tissue (see also Table 1). In this connection, the following relationships are produced for the calculation of the infiltration:

$${SLR}_{CellType / Control} = {log}_{b} ( \frac{{S}_{CellType}}{{S}_{Control}} )$$

$$and$$

$${SLR}_{Sample / Control} = {log}_{b} ( \frac{{S}_{Sample}}{{S}_{Control}} ) .$$

Together with Equation 1, there follows therefrom:

$${log}_{b} ( {K}_{CellType} ) = {SLR}_{CellType / Control} \cdot \frac{1}{k} + {log}_{b} ( {K}_{Control} ) \\ or \\ {K}_{CellType} = {K}_{Control} \cdot {2}^{\frac{1}{k} \cdot {SLR}_{CellType / Control}} \qquad ( Equation 12 )$$

and analogously

$${K}_{Sample} = {K}_{Control} \cdot {2}^{\frac{1}{k} \cdot {SLR}_{CellType / Control}} \qquad ( Equation 13 )$$

With use of the Equations 11, 12 and 13, there follows for the proportion of a cell type measured in the SLR values of marker genes:

$${A}_{CellType} = {2}^{\frac{1}{k} ( {SLR}_{Sample / Control} - {SLR}_{CellType / Control} )} \qquad ( Equation 14 )$$

For the two models M₁ and M₂, the value for the slope k is produced from the Equations 5 and 6.

Equation 14 can be applied to several genes that are suitable for the assessment of the proportions of a cell type in a cell mixture (see Tables 2 and 3). The mean from the proportions calculated per gene provides a measure of the proportion of the cell type in the sample to be examined.

### Identification of Regulated Genes by Calculation of the Virtual Profiles from the Cellular Composition

If the various cellular components of a sample and their proportional distribution are known, an expected mix profile can be calculated from the profiles for each cell type.

### 1. Background: The Cell Type is Lacking in the Normal Situation

For the synovial tissue, the background follows that the normal tissue does not contain any immune cells. This corresponds to the above-mentioned control tissue. The infiltration in the case of disease can be calculated via the marker genes of various cell populations, as depicted above (Equation 11 or 14). The proportions of the respective cell types and the normal tissue add up to 100%.

In addition, the concentration K_{Cell Type} can be determined with Equation 12 for each gene expressed in a cell type. The concentration K_{Control} in the control tissue, the normal synovial tissue, is determined with the signal S_{Control} of the relevant gene according to Equation 8.

The expected concentration K′_{Sample} of a gene, which is to be expected based on the cellular composition, is then calculated according to Equation 3 as follows:

$${K}_{Sample}^{′} = {A}_{Control} \cdot {K}_{Control} + {\sum }_{i = 1}^{n} ( {A}_{i} \cdot {K}_{i} ) \qquad ( Equation 15 )$$

The related logarithmized value of the signal is produced via Equation 1 with

log_{b}(S′_{Sample})=k·log_{b}(K′_{Sample})+log_{b}(Sₘᵢₙ) (Equation 16)

with k according to model M₁ or M₂ from Equations 5 and 6.

The measured difference between diseased synovial tissue and normal synovial tissue is produced as

SLR_{Sample/Control}

The proportion of the regulation SLR_{regulated} is produced by subtraction of the infiltration:

$${SLR}_{Regulated} = {log}_{b} \frac{{S}_{Sample}}{{S}_{Sample}^{′}} = {SLR}_{Sample / Control} - {log}_{b} \frac{{S}_{Sample}^{′}}{{S}_{Control}} \qquad ( Equation 17 )$$

As an alternative, the concentration difference (concentration log ratio; CLR) can be calulated in the same way with use of Equations 13 and 15:

$${CLR}_{Regulated} = {log}_{b} \frac{{K}_{Sample}}{{K}_{Sample}^{′}} = \frac{{K}_{Control} \cdot {2}^{\frac{1}{k} \cdot {SLR}_{Sample / Control}}}{{A}_{Control} \cdot {K}_{ Control} + {\sum }_{i = 1}^{n} ( {A}_{i} \cdot {K}_{i} )} \qquad ( Equation 18 )$$

with k according to model M₁ or M₂ from the Equations 5 and 6.

### 2. Background: The Cell Type is Present in the Normal Situation

In whole blood, the various immune cells are already present in the normal situation. Therefore, the “normal situation” is analyzed first.

### Determination of the Normal Situation

The calculations are executed immediately with the determined signals that are matched to one another. Alternatively, the reference to a control tissue, which does not contain the various cell types, such as, e.g., the normal synovial tissue, can be used with the aid of the comparison algorithm developed by Affymetrix and with consideration of the perfect match and mismatch data. The concentration K_{Control} thus is calculated from Equation 10 or 13. The proportions of the individual cell types are assessed according to Equation 11 from the concentrations of the marker genes or the SLRs according to Equation 14.

To calculate the overall concentration, the proportion of residual populations that are not present as individual profiles is deficient. The latter can be combined into a separate virtual “residual population.” Their proportion is produced as follows:

$${A}_{K , Residue} = 1 - {\sum }_{i = 1}^{n} {A}_{K , i} \qquad ( Equation 19 )$$

The proportion of the residual population can be minute, and the calculated expected concentration that consists of the signatures and their proportions exceeds the actually measured values, i.e.,

$${K}_{Control} - {\sum }_{i = 1}^{n} ( {A}_{K , i} \cdot {K}_{i} ) < 0$$

For this case, a uniform matching of the concentrations Kᵢ is necessary for each cell type i. Assuming that there is no contribution from the residual profile, i.e., the expression of the gene in the residual profile is below the detection limit, the correction factor is produced as follows:

$$KF = \frac{{K}_{Control}}{{A}_{K , Residue} \cdot {K}_{Residue} + {\sum }_{i = 1}^{n} ( {A}_{K , i} \cdot {K}_{i} )} \qquad ( Equation 20 )$$

with K_{Residue}<Kₘᵢₙ. Here, e.g., a value of K_{Residue}=0.5 can be used.

The concentration for each gene in the profile of the virtual residual population is produced with use of Equation 3 as

$${K}_{Residue} = \frac{1}{{A}_{K , Residue}} \cdot ( {K}_{Control} - {\sum }_{i = 1}^{n} ( {A}_{K , i} \cdot {K}_{i} ) ) \qquad ( Equation 21 )$$

Thus, the sum from the calculated individual components of the concentrations is identical to the concentration calculated from the actual measurement, i.e.,

$${K}_{Control} = {A}_{K , Residue} \cdot {K}_{Residue} + {\sum }_{i = 1}^{n} ( {A}_{K , i} \cdot {K}_{i} ) \qquad ( Equation 22 )$$

For each gene, the calculated concentrations K_{Residue} of the residual populations from all normal donors are averaged. Thus, a virtual signature for the residual population of the normal donor is produced comparably to the measured signatures of the various cell types. In this connection, all requirements for the calculation of the normal situation based on the cell signatures that are present and a virtual normal residual profile are provided.

### Determination in the Disease Situation

The calculations are executed analogously to the normal situation directly with the determined signals that are matched to one another. As an alternative, with the aid of the Affymetrix-developed comparison algorithm, the reference to the same control tissue as for normal donors can be used. The concentration K_{Sample} thus is calculated from Equation 10 or 13. The proportions of the individual cell types are assessed according to Equation 11 from the concentrations of the marker genes or the SLRs according to Equation 14. The proportion of the residual population follows from Equation 19.

The expected concentration according to the cellular composition is calculated from the individual components according to Equation 22:

$${K}_{Sample}^{′} = {A}_{P , Residue} \cdot {K}_{Residue} + {\sum }_{i = 1}^{n} ( {A}_{P , i} \cdot {K}_{i} )$$

The expected signals are calculated from Equation 16. The regulated genes, which cannot be attributed to the known signatures, are produced either via the SLRs according to Equation 17 or the CLRs according to Equation 18.

### Application of the Calculation Process for Characterizing Gene Expression Profiles

The separation into individual components is carried out in steps.

1. Division into partial components of cell-type signatures.

2. Detection of functional signatures

3. Examination of mutual dependencies between 1. and 2.

4. Correlation with clinical features.

The comparison between two complex samples first yields a differential gene expression, which can be caused both by differences of the cellular composition as well as by gene regulation. In the first step, therefore, the cellular composition is classified. This takes place with use of signatures that characterize various cell types. By using normal signatures for tissue and individual cell types, an expected profile is calculated that only considers the normal gene expression. The difference from this virtual profile and the actually measured profile produces the genes that are changed either by additional, still not considered, cell types or by regulation. Functional changes in the gene expression are therefore to be expected in this difference. An assignment to a specific cell type is not possible at first. These genes, however, are evident from the functional change in the cells in question.

$${K}_{Sample} = {\sum }_{i = 1}^{n} {A}_{i} \cdot {K}_{i} + {\sum }_{i = 1}^{n} {A}_{i} \cdot {K}_{i , reg}$$

with the concentration Kᵢ in the normal state and the concentration change K_{i,reg}, which in addition is produced by the functional regulation with i as the number of the various involved cell types.

The study of individual cell types under functional influences can yield a functional signature for a cell type. This functional change can be produced as follows:

K_{i,f}=Kᵢ+K_{i,reg}.

A functional concentration change that is purified of the signature of the cell type is produced therefrom

K_{i,reg}=K_{i,f}−Kᵢ.

If marker genes are defined for the functional signature that is purified of the cell type, the proportion of this signature can be estimated quantitatively, unlike between virtual profile and actually measured profile. These functional profiles can now be inferred in steps from the difference between virtual profile and actually measured profile.

Altogether, parameters for the cellular composition and molecular functions are created that can be correlated with one another as well as with clinical features. As a result, new rating scales are produced for the interpretation of array data, which provide a decisive improvement both for the diagnosis and for the identification of therapeutically significant target structures or regulation mechanisms.

### Application to the Example of Synovial Tissue.

The above-mentioned process was applied to the analysis of a total of 10 different samples of patients with rheumatoid arthritis (RA), 10 patients with osteoarthritis (OA) and 10 normal synovial tissues. The selected genes labeled 1 in Table 2 were used for the assessment of the proportions of CD4+ T cells, monocytes and granulocytes in the synovial tissue of the RA and OA patients. The proportional distribution for RA or OA, mentioned in Table 4, resulted.

Based on the depicted calculation bases and the application of model M₁, the proportions that can be expected per gene by infiltration of T cells, monocytes or granulocytes were determined. From the difference between the expected expression level above the calculation base according to model M₁ and the actually measured expression level, the proportion of the expression differences induced by activation resulted. First, the genes were determined, which, by means of the software MAS 5.0 developed by Affymetrix, produced a difference in more than 50% of all comparisons in pairs between RA and normal tissue with a mean SLR of greater than 1.5. The thus obtained gene entries were further divided into groups that meet the following conditions:
1. Infiltrated genes, when the ratio of the SLR_{Sample/Sample} to the SLR_{Sample/Control} was under 0.25
2. Regulated genes or genes of other migrating cell types, which were not yet considered, when the ratio of the SLR_{Sample/Sample} to the SLR_{Sample/Control} was over 0.75
3. Genes that were both infiltrated and regulated or can originate from other cell types not taken into consideration, when the ratio of the SLR_{Sample/Sample} to the SLR_{Sample/Control} was between 0.25 and 0.75.

The gene entries found under the first condition are indicated below in Table 5. They represent a gene pool that can be used in the case of a chronic inflammatory joint disease such as rheumatoid arthritis as a diagnostic agent for the extent of the infiltration, in particular of T cells, monocytes or granulocytes. These genes alone can already represent criteria for the diagnosis of inflammatory joint diseases. For osteoarthritis, a comparatively considerably lower infiltration resulted (FIG. 5, hierarchical cluster analysis with the genes of Table 5 between RA, OA and normal tissue). Also, for a division into subgroups of various RA patients, infiltration differences are produced that can be identified both in this selection of genes and via the comparison of the infiltration portions based on the marker genes (FIG. 6). The signals of these genes can be used without prior calculation for the diagnostic studies, since they mainly are produced by infiltration.

The gene entries found under the second condition are indicated below in Table 6. They represent a gene pool that can be used as a diagnostic agent for the characteristic type of gene regulation. Here, differences between individual RA patients can be identified and subdivisions are possible. These include divisions according to the type of arthritis, stage of the disease, prognosis of the disease, assignment to an optimum form of therapy, and assessment or monitoring of the course of the response rate to a specific therapy. Thus, new markers or marker groups that can be correlated as molecular features with different clinical features or expected feature developments are produced and therefore gain diagnostic importance. Also, these signals could be used immediately for diagnosis without previous calculation of the infiltration or activation, since they are primarily produced by activation. Nevertheless, the calculation of the signal portion produced in gene activation can also bring about an improvement in the interpretation here. A subdivision into subgroups is depicted in FIG. 7.

The gene entries identified under the third condition are indicated in Table 7. They also represent a diagnostically important gene pool, which, however, must first be converted into signals, which reflect the regulation or infiltration portion, for differentiation from infiltration and activation (solving of Equation 16 according to S′_{Sample}).

The signal portion induced by regulation was determined for the genes that are produced in combination by the second or third condition. Also, the portion induced by infiltration could be further examined in an analogous way. After conversion into the regulated signal portion, a hierarchical cluster analysis was executed. The result is depicted in FIG. 8. Obvious distinguishing features are produced for the two subgroups RA 1, 2, 4, 5, 8, 10 and RA 3, 6, 7, 9. To identify the genes that are relevant for the differentiation, a t-test analysis was applied to the calculated signals from all genes from the conditions 2 and 3. This resulted in the gene entries indicated in Table 8, which make possible a differentiation. FIG. 9 shows the cluster analysis and related principal component analysis.

Based on the example depicted, it was shown how the method contributes to defining new meanings for genes and gene groups, which are important both for the diagnosis and for the development of new therapy strategies. Thus, genes or their importance in the assessment of inflammatory joint diseases were newly defined with respect to infiltration and in particular with respect to activation as a measure of the active participation and thus pathophysiological importance in the disease process.

TABLE 1
Samples and Signatures That are Used for Creating the Calculation

| Sample or Cell Type | Data | Use as |
|---|---|---|
| Normal Donor Synovial | Healthy Tissue without | Control, Signature of a |
| Tissue | Infiltration | Fibroblastoid Tissue |
| Rheumatoid Arthritis | Diseased Tissue | Sample to be Examined |
| Synovial Tissue | | |
| Normal Donor Whole Blood | Healthy “Tissue” with Variable | Control |
| | Composition | |
| Rheumatoid Arthritis Whole | Diseased “Tissue” with | Sample to be Examined |
| Blood | Variable Composition | |
| Arthrosis Synovial Tissue | Diseased Tissue | Comparison between Various |
| | | Diseases |
| Normal Donor CD4+ T | Expression Profile in the | CD4+ T-Cell Signature |
| Cells | Normal State | |
| Rheumatoid Arthritis | Expression Profile in the | Identification of Regulated |
| CD4+ T Cells | Disease Situation | T-Cell Genes |
| Normal Donor CD8+ T | Expression Profile in the | CD8+ T-Cell Signature |
| Cells | Normal State | |
| Normal Donor CD14+ | Expression Profile in the | Monocyte Signature |
| Monocytes | Normal State | |
| Rheumatoid Arthritis | Expression Profile in the | Identification of Regulated |
| CD14+ Monocytes | Disease Situation | Monocyte Genes |
| Normal Donor CD15+ | Expression Profile in the | Granulocyte Signature |
| Granulocytes | Normal State | |
| Rheumatoid Arthritis | Expression Profile in the | Identification von Regulated |
| CD15+ Neutrophilic | Disease Situation | Granulocyte Genes |
| Granulocytes | | |
| Cartilage Cells, Cartilage | Independent Tissue | Expanded Background Data |
| Tissue and Cultivated | | for the Determination of the |
| Synovial Fibroblasts | | Dynamic Range |

TABLE 2
Marker Genes That are Used

| | | | | | |
|---|---|---|---|---|---|
| | Gen | | | | |
| Affymetrix_ID | Symbol | Unigene | Name | Selection | S_min |

Table 2A:
Selection List for Monocyte-Marker Genes:
The genes were expressed with an at least 4-fold increase in all monocyte populations
examined in comparison to other cell types or non-infiltrated tissues.

| | | | | | |
|---|---|---|---|---|---|
| 201850_at | CAPG | Hs.82422 | capping protein (actin filament), gelsolin-like | 0 | 126.8 |
| 202295_s_at | CTSH | Hs.114931 | cathepsin H | 0 | 76.3 |
| 202944_at | NAGA | Hs.75372 | N-acetylgalactosaminidase, alpha- | 0 | 77.8 |
| 203300_x_at | AP1S2 | Hs.40368 | adaptor-related protein complex 1, sigma 2 | 0 | 68.6 |
| | | | subunit | | |
| 203922_s_at | CYBB | Hs.88974 | cytochrome b-245, beta polypeptide (chronic | 0 | 54.55 |
| | | | granulomatous disease) | | |
| 203923_s_at | CYBB | Hs.88974 | cytochrome b-245, beta polypeptide (chronic | 0 | 58.6 |
| | | | granulomatous disease) | | |
| 203932_at | HLA- | Hs.1162 | major histocompatibility complex, class II, | 0 | 74.4 |
| | DMB | | DM beta | | |
| 204057_at | ICSBP1 | Hs.14453 | interferon consensus sequence binding protein 1 | 0 | 78.95 |
| 204081_at | NRGN | Hs.232004 | neurogranin (protein kinase C substrate, RC3) | 0 | 110.4 |
| 204588_s_at | SLC7A7 | Hs.194693 | solute carrier family 7 (cationic amino acid | 0 | 193.1 |
| | | | transporter, y+ system), member 7 | | |
| 204619_s_at | CSPG2 | Hs.434488 | chondroitin sulfate proteoglycan 2 (versican) | 0 | 34.7 |
| 205076_s_at | CRA | Hs.425144 | cisplatin resistance associated | 0 | 122.8 |
| 205552_s_at | OAS1 | Hs.442936 | 2′,5′-oligoadenylate synthetase 1, 40/46 kDa | 0 | 86.4 |
| 205685_at | CD86 | Hs.27954 | CD86 antigen (CD28 antigen ligand 2, B7-2 | 1 | 46.9 |
| | | | antigen) | | |
| 205686_s_at | CD86 | Hs.27954 | CD86 antigen (CD28 antigen ligand 2, B7-2 | 0 | 112.6 |
| | | | antigen) | | |
| 205789_at | CD1D | Hs.1799 | CD1D antigen, d polypeptide | 0 | 28.1 |
| 205859_at | LY86 | Hs.184018 | lymphocyte antigen 86 | 1 | 219.5 |
| 206120_at | CD33 | Hs.83731 | CD33 antigen (gp67) | 1 | 124.8 |
| 206130_s_at | ASGR2 | Hs.1259 | asialoglycoprotein receptor 2 | 0 | 186.1 |
| 206214_at | PLA2G7 | Hs.93304 | phospholipase A2, group VII (platelet- | 1 | 16.8 |
| | | | activating factor acetylhydrolase, plasma) | | |
| 206715_at | TFEC | Hs.125962 | transcription factor EC | 0 | 45.6 |
| 206743_s_at | ASGR1 | Hs.12056 | asialoglycoprotein receptor 1 | 0 | 55.5 |
| 206978_at | CCR2 | Hs.511794 | chemokine (C-C motif) receptor 2 | 1 | 69 |
| 208146_s_at | CPVL | Hs.95594 | carboxypeptidase, vitellogenic-like | 0 | 68.2 |
| 208450_at | LGALS2 | Hs.113987 | lectin, galactoside-binding, soluble, 2 | 1 | 54.05 |
| | | | (galectin 2) | | |
| 208771_s_at | LTA4H | Hs.81118 | leukotriene A4 hydrolase | 0 | 68.6 |
| 208890_s_at | PLXNB2 | Hs.3989 | plexin B2 | 0 | 188.5 |
| 209555_s_at | CD36 | Hs.443120 | CD36 antigen (collagen type I receptor, | 1 | 116.85 |
| | | | thrombospondin receptor) | | |
| 210222_s_at | RTN1 | Hs.99947 | reticulon 1 | 1 | 37.2 |
| 210314_x_at | TNFSF13 | Hs.54673 | tumor necrosis factor (ligand) superfamily, | 0 | 54.9 |
| | | | member 13 | | |
| 210895_s_at | CD86 | Hs.27954 | CD86 antigen (CD28 antigen ligand 2, B7-2 | 0 | 170.35 |
| | | | antigen) | | |
| 213385_at | CHN2 | Hs.407520 | chimerin (chimaerin) 2 | 0 | 52.85 |
| 214058_at | MYCL1 | Hs.437922 | v-myc myelocytomatosis viral oncogene | 1 | 61.25 |
| | | | homolog 1, lung carcinoma derived (avian) | | |
| 217478_s_at | HLA- | Hs.351279 | major histocompatibility complex, class II, | 0 | 109.1 |
| | DMA | | DM alpha | | |
| 219574_at | FLJ20668 | Hs.136900 | hypothetical protein FLJ20668 | 0 | 32.55 |
| 219714_s_at | CACNA2D3 | Hs.435112 | calcium channel, voltage-dependent, alpha | 0 | 95.6 |
| | | | 2/delta 3 subunit | | |
| 219806_s_at | FN5 | Hs.416456 | FN5 protein | 0 | 121.8 |
| 220091_at | SLC2A6 | Hs.244378 | solute carrier family 2 (facilitated glucose | 0 | 103.95 |
| | | | transporter), member 6 | | |
| 220307_at | CD244 | Hs.157872 | natural killer cell receptor 2B4 | 0 | 252.45 |

Table 2B:
Selection List for T-Cell-Marker Genes:
The genes were expressed with an at least 8-fold increase in all T-cell populations
examined in comparison to other cell types or non-infiltrated tissues.

| | | | | | |
|---|---|---|---|---|---|
| 202478_at | TRB2 | Hs.155418 | tribbles homolog 2 | 0 | 14.8 |
| 202524_s_at | SPOCK2 | Hs.436193 | sparc/osteonectin, cwcv and kazal-like | 0 | 83.6 |
| | | | domains proteoglycan (testican) 2 | | |
| 203385_at | DGKA | Hs.172690 | diacylglycerol kinase, alpha 80 kDa | 0 | 86.95 |
| 203413_at | NELL2 | Hs.79389 | NEL-like 2 (chicken) | 0 | 75 |
| 203685_at | BCL2 | Hs.79241 | B-cell CLL/lymphoma 2 | 0 | 49.5 |
| 203828_s_at | NK4 | Hs.943 | natural killer cell transcript 4 | 0 | 255.35 |
| 204777_s_at | MAL | Hs.80395 | mal, T-cell differentiation protein | 0 | 53.2 |
| 204890_s_at | LCK | Hs.1765 | lymphocyte-specific protein tyrosine kinase | 0 | 43.2 |
| 204891_s_at | LCK | Hs.1765 | lymphocyte-specific protein tyrosine kinase | 0 | 61.85 |
| 204960_at | PTPRCAP | Hs.155975 | protein tyrosine phosphatase, receptor type, | 0 | 224.7 |
| | | | C-associated protein | | |
| 205255_x_at | TCF7 | Hs.169294 | transcription factor 7 (T-cell specific, HMG- | 0 | 229.8 |
| | | | box) | | |
| 205456_at | CD3E | Hs.3003 | CD3E antigen, epsilon polypeptide (TiT3 | 0 | 85.4 |
| | | | complex) | | |
| 205488_at | GZMA | Hs.90708 | granzyme A (granzyme 1, cytotoxic T- | 0 | 53.3 |
| | | | lymphocyte-associated serine esterase 3) | | |
| 205590_at | RASGRP1 | Hs.189527 | RAS guanyl releasing protein 1 (calcium and | 0 | 2.6 |
| | | | DAG-regulated) | | |
| 205790_at | SCAP1 | Hs.411942 | src family associated phosphoprotein 1 | 0 | 91.65 |
| 205798_at | IL7R | Hs.362807 | interleukin 7 receptor | 0 | 82.5 |
| 205831_at | CD2 | Hs.89476 | CD2 antigen (p50), sheep red blood cell | 0 | 66.5 |
| | | | receptor | | |
| 206150_at | TNFRSF7 | Hs.355307 | tumor necrosis factor receptor superfamily, | 0 | 65.6 |
| | | | member 7 | | |
| 206337_at | CCR7 | Hs.1652 | chemokine (C-C motif) receptor 7 | 0 | 66.65 |
| 206545_at | CD28 | Hs.1987 | CD28 antigen (Tp44) | 0 | 25 |
| 206761_at | CD96 | Hs.142023 | CD96 antigen | 0 | 54.4 |
| 206804_at | CD3G | Hs.2259 | CD3G antigen, gamma polypeptide (TiT3 | 0 | 34.5 |
| | | | complex) | | |
| 206828_at | TXK | Hs.29877 | TXK tyrosine kinase | 0 | 32.4 |
| 206980_s_at | FLT3LG | Hs.428 | fms-related tyrosine kinase 3 ligand | 0 | 109 |
| 206983_at | CCR6 | Hs.46468 | chemokine (C-C motif) receptor 6 | 0 | 14 |
| 207651_at | H963 | Hs.159545 | platelet activating receptor homolog | 0 | 38.8 |
| 209504_s_at | PLEKHB1 | Hs.445489 | pleckstrin homology domain containing, | 0 | 16.8 |
| | | | family B (evectins) member 1 | | |
| 209602_s_at | GATA3 | Hs.169946 | GATA binding protein 3 | 0 | 23.9 |
| 209604_s_at | GATA3 | Hs.169946 | GATA binding protein 3 | 0 | 72.1 |
| 209670_at | TRA@ | Hs.74647 | T cell receptor alpha locus | 1 | 93.7 |
| 209671_x_at | TRA@ | Hs.74647 | T cell receptor alpha locus | 1 | 77.1 |
| 209871_s_at | APBA2 | Hs.26468 | amyloid beta (A4) precursor protein-binding, | 0 | 26 |
| | | | family A, member 2 (X11-like) | | |
| 209881_s_at | LAT | Hs.498997 | linker for activation of T cells | 0 | 237.8 |
| 210031_at | CD3Z | Hs.97087 | CD3Z antigen, zeta polypeptide (TiT3 | 0 | 137.75 |
| | | | complex) | | |
| 210038_at | PRKCQ | Hs.408049 | protein kinase C, theta | 0 | 159.95 |
| 210116_at | SH2D1A | Hs.151544 | SH2 domain protein 1A, Duncan's disease | 0 | 45.9 |
| | | | (lymphoproliferative syndrome) | | |
| 210370_s_at | LY9 | Hs.403857 | lymphocyte antigen 9 | 0 | 322.7 |
| 210439_at | ICOS | Hs.56247 | inducible T-cell co-stimulator | 0 | 46.3 |
| 210607_at | FLT3LG | Hs.428 | fms-related tyrosine kinase 3 ligand | 0 | 19.75 |
| 210847_x_at | TNFRSF25 | Hs.299558 | tumor necrosis factor receptor superfamily, | 0 | 19.15 |
| | | | member 25 | | |
| 210915_x_at | — | Hs.419777 | Homo sapiens T cell receptor beta chain | 1 | 79.2 |
| | | | BV20S1 BJ1-5 BC1 mRNA, complete cds | | |
| 210948_s_at | LEF1 | Hs.44865 | lymphoid enhancer-binding factor 1 | 0 | 57.55 |
| 210972_x_at | TRA@ | Hs.74647 | T cell receptor alpha locus | 1 | 124.8 |
| 211005_at | LAT | Hs.498997 | linker for activation of T cells | 0 | 74.7 |
| 211272_s_at | DGKA | Hs.172690 | diacylglycerol kinase, alpha 80 kDa | 0 | 54.15 |
| 211282_x_at | TNFRSF25 | Hs.299558 | tumor necrosis factor receptor superfamily, | 0 | 223.8 |
| | | | member 25 | | |
| 211339_s_at | ITK | Hs.211576 | IL2-inducible T-cell kinase | 0 | 22.3 |
| 211796_s_at | — | Hs.419777 | Homo sapiens T cell receptor beta chain | 1 | 33.3 |
| | | | BV20S1 BJ1-5 BC1 mRNA, complete cds | | |
| 211841_s_at | TNFRSF25 | Hs.299558 | tumor necrosis factor receptor superfamily, | 0 | 61.6 |
| | | | member 25 | | |
| 211902_x_at | — | — | — | 0 | 89.65 |
| 212400_at | — | Hs.460208 | Homo sapiens mRNA; cDNA | 0 | 13.45 |
| | | | DKFZp586A0618 (from clone | | |
| | | | DKFZp586A0618) | | |
| 212414_s_at | SEPT6 | Hs.90998 | septin 6 | 0 | 56.4 |
| 213193_x_at | — | Hs.419777 | Homo sapiens T cell receptor beta chain | 1 | 62.9 |
| | | | BV20S1 BJ1-5 BC1 mRNA, complete cds | | |
| 213534_s_at | PASK | Hs.397891 | PAS domain containing serine/threonine | 0 | 46.15 |
| | | | kinase | | |
| 213539_at | CD3D | Hs.95327 | CD3D antigen, delta polypeptide (TiT3 | 0 | 74.25 |
| | | | complex) | | |
| 213587_s_at | C7orf32 | Hs.351612 | chromosome 7 open reading frame 32 | 0 | 88.7 |
| 213906_at | MYBL1 | Hs.300592 | v-myb myeloblastosis viral oncogene | 0 | 23.85 |
| | | | homolog (avian)-like 1 | | |
| 213958_at | CD6 | Hs.436949 | CD6 antigen | 0 | 149.4 |
| 214032_at | ZAP70 | Hs.234569 | zeta-chain (TCR) associated protein kinase | 0 | 84.8 |
| | | | 70 kDa | | |
| 214049_x_at | CD7 | Hs.36972 | CD7 antigen (p41) | 0 | 26.65 |
| 214470_at | KLRB1 | Hs.169824 | killer cell lectin-like receptor subfamily B, | 0 | 240.6 |
| | | | member 1 | | |
| 214551_s_at | CD7 | Hs.36972 | CD7 antigen (p41) | 0 | 59.2 |
| 214617_at | PRF1 | Hs.2200 | perforin 1 (pore forming protein) | 0 | 77.7 |
| 215967_s_at | LY9 | Hs.403857 | lymphocyte antigen 9 | 0 | 117.8 |
| 216920_s_at | TRG@ | Hs.385086 | T cell receptor gamma locus | 0 | 156.75 |
| 216945_x_at | PASK | Hs.397891 | PAS domain containing serine/threonine | 0 | 57.7 |
| | | | kinase | | |
| 217147_s_at | TRIM | Hs.138701 | T-cell receptor interacting molecule | 0 | 32.65 |
| 217838_s_at | EVL | Hs.241471 | Enah/Vasp-like | 0 | 76.4 |
| 217950_at | NOSIP | Hs.7236 | nitric oxide synthase interacting protein | 0 | 125.8 |
| 218237_s_at | SLC38A1 | Hs.132246 | solute carrier family 38, member 1 | 0 | 69 |
| 219423_x_at | TNFRSF25 | Hs.299558 | tumor necrosis factor receptor superfamily, | 0 | 74 |
| | | | member 25 | | |
| 219528_s_at | BCL11B | Hs.57987 | B-cell CLL/lymphoma 11B (zinc finger | 0 | 25 |
| | | | protein) | | |
| 219541_at | FLJ20406 | Hs.149227 | hypothetical protein FLJ20406 | 0 | 141.55 |
| 219812_at | STAG3 | Hs.323634 | stromal antigen 3 | 0 | 6.5 |
| 220418_at | UBASH3A | Hs.183924 | ubiquitin associated and SH3 domain | 0 | 92.4 |
| | | | containing, A | | |
| 221081_s_at | FLJ22457 | Hs.447624 | hypothetical protein FLJ22457 | 0 | 12.6 |
| 221558_s_at | LEF1 | Hs.44865 | lymphoid enhancer-binding factor 1 | 0 | 13.55 |
| 221756_at | MGC17330 | Hs.26670 | HGFL gene | 0 | 141.6 |
| 221790_s_at | ARH | Hs.184482 | LDL receptor adaptor protein | 0 | 96.2 |
| 39248_at | AQP3 | Hs.234642 | aquaporin 3 | 0 | 18 |

Table 2C:
Selection List for Granulocyte-Marker Genes:
The genes were expressed with an at least 8-fold increase in all neutrophilic
granulocyte population populations examined in comparison to other cell types or non-
infiltrated tissues.

| | | | | | |
|---|---|---|---|---|---|
| 202018_s_at | LTF | Hs.437457 | lactotransferrin | 0 | 231.75 |
| 202083_s_at | SEC14L1 | Hs.75232 | SEC14-like 1 (S. cerevisiae) | 1 | 25.6 |
| 202193_at | LIMK2 | Hs.278027 | LIM domain kinase 2 | 1 | 33.45 |
| 203434_s_at | MME | Hs.307734 | membrane metallo-endopeptidase (neutral | 0 | 54.7 |
| | | | endopeptidase, enkephalinase, CALLA, | | |
| | | | CD10) | | |
| 203435_s_at | MME | Hs.307734 | membrane metallo-endopeptidase (neutral | 1 | 190.6 |
| | | | endopeptidase, enkephalinase, CALLA, | | |
| | | | CD10) | | |
| 203691_at | PI3 | Hs.112341 | protease inhibitor 3, skin-derived (SKALP) | 1 | 46.7 |
| 203936_s_at | MMP9 | Hs.151738 | matrix metalloproteinase 9 (gelatinase B, | 0 | 68.6 |
| | | | 92 kDa gelatinase, 92 kDa type IV | | |
| | | | collagenase) | | |
| 204006_s_at | FCGR3A | Hs.372679 | Fc fragment of IgG, low affinity IIIa, receptor | 0 | 77.9 |
| | | | for (CD16) | | |
| 204007_at | FCGR3A | Hs.372679 | Fc fragment of IgG, low affinity IIIa, receptor | 0 | 57 |
| | | | for (CD16) | | |
| 204307_at | KIAA0329 | Hs.11711 | KIAA0329 gene product | 0 | 54.7 |
| 204308_s_at | KIAA0329 | Hs.11711 | KIAA0329 gene product | 1 | 88.8 |
| 204351_at | S100P | Hs.2962 | S100 calcium binding protein P | 0 | 94.1 |
| 204409_s_at | EIF1AY | Hs.461178 | eukaryotic translation initiation factor 1A, Y- | 0 | 24 |
| | | | linked | | |
| 204542_at | STHM | Hs.288215 | sialyltransferase | 0 | 131 |
| 204669_s_at | RNF24 | Hs.30524 | ring finger protein 24 | 0 | 87 |
| 205033_s_at | DEFA1 | Hs.511887 | defensin, alpha 1, myeloid-related sequence | 0 | 71.7 |
| 205220_at | HM74 | Hs.458425 | putative chemokine receptor | 0 | 77.95 |
| 205227_at | IL1RAP | Hs.143527 | interleukin 1 receptor accessory protein | 0 | 46.8 |
| 205403_at | IL1R2 | Hs.25333 | interleukin 1 receptor, type II | 1 | 62.85 |
| 205645_at | REPS2 | Hs.334168 | RALBP1 associated Eps domain containing 2 | 1 | 46.35 |
| 205920_at | SLC6A6 | Hs.1194 | solute carrier family 6 (neurotransmitter | 0 | 114 |
| | | | transporter, taurine), member 6 | | |
| 206177_s_at | ARG1 | Hs.440934 | arginase, liver | 0 | 27.2 |
| 206208_at | CA4 | Hs.89485 | carbonic anhydrase IV | 0 | 47.9 |
| 206222_at | TNFRSF10C | Hs.119684 | tumor necrosis factor receptor superfamily, | 0 | 39.7 |
| | | | member 10c, decoy without an intracellular | | |
| | | | domain | | |
| 206515_at | CYP4F3 | Hs.106242 | cytochrome P450, family 4, subfamily F, | 0 | 28.6 |
| | | | polypeptide 3 | | |
| 206522_at | MGAM | Hs.122785 | maltase-glucoamylase (alpha-glucosidase) | 0 | 54.8 |
| 206676_at | CEACAM8 | H.41 | carcinoembryonic antigen-related cell | 0 | 98.9 |
| | | | adhesion molecule 8 | | |
| 206765_at | KCNJ2 | Hs.1547 | potassium inwardly-rectifying channel, | 1 | 108.5 |
| | | | subfamily J, member 2 | | |
| 206877_at | MAD | Hs.379930 | MAX dimerization protein 1 | 0 | 92.05 |
| 206925_at | SIAT8D | Hs.308628 | sialyltransferase 8D (alpha-2, 8- | 0 | 39.2 |
| | | | polysialyltransferase) | | |
| 207008_at | IL8RB | Hs.846 | interleukin 8 receptor, beta | 1 | 43.6 |
| 207094_at | IL8RA | Hs.194778 | interleukin 8 receptor, alpha | 1 | 124.6 |
| 207275_s_at | FACL2 | Hs.511920 | fatty-acid-Coenzyme A ligase, long-chain 2 | 0 | 72.65 |
| 207384_at | PGLYRP | Hs.137583 | peptidoglycan recognition protein | 0 | 238.15 |
| 207387_s_at | GK | Hs.1466 | glycerol kinase | 0 | 47.7 |
| 207890_s_at | MMP25 | Hs.290222 | matrix metalloproteinase 25 | 1 | 72.3 |
| 207907_at | TNFSF14 | Hs.129708 | tumor necrosis factor (ligand) superfamily, | 0 | 92.8 |
| | | | member 14 | | |
| 208304_at | CCR3 | Hs.506190 | chemokine (C-C motif) receptor 3 | 0 | 32 |
| 208748_s_at | FLOT1 | Hs.179986 | flotillin 1 | 0 | 113.7 |
| 209369_at | ANXA3 | Hs.442733 | annexin A3 | 0 | 24 |
| 209776_s_at | SLC19A1 | Hs.84190 | solute carrier family 19 (folate transporter), | 0 | 74.95 |
| | | | member 1 | | |
| 210119_at | KCNJ15 | Hs.17287 | potassium inwardly-rectifying channel, | 1 | 49.9 |
| | | | subfamily J, member 15 | | |
| 210244_at | CAMP | Hs.51120 | cathelicidin antimicrobial peptide | 0 | 228.9 |
| 210484_s_at | MGC31957 | Hs.253829 | hypothetical protein MGC31957 | 0 | 52.5 |
| 210724_at | EMR3 | Hs.438468 | egf-like module-containing mucin-like | 1 | 50.8 |
| | | | receptor 3 | | |
| 210773_s_at | FPRL1 | Hs.99855 | formyl peptide receptor-like 1 | 0 | 104.45 |
| 211163_s_at | TNFRSF10C | Hs.119684 | tumor necrosis factor receptor superfamily, | 1 | 85.1 |
| | | | member 10c, decoy without an intracellular | | |
| | | | domain | | |
| 211372_s_at | IL1R2 | Hs.25333 | interleukin 1 receptor, type II | 0 | 110.8 |
| 211574_s_at | MCP | Hs.83532 | membrane cofactor protein (CD46, | 0 | 192.3 |
| | | | trophoblast-lymphocyte cross-reactive | | |
| | | | antigen) | | |
| 213506_at | F2RL1 | Hs.154299 | coagulation factor II (thrombin) receptor-like 1 | 0 | 56.2 |
| 214455_at | HIST1H2BC | Hs.356901 | histone 1, H2bc | 0 | 25.85 |
| 215071_s_at | — | — | — | 0 | 75 |
| 215719_x_at | TNFRSF6 | Hs.82359 | tumor necrosis factor receptor superfamily, | 0 | 37.6 |
| | | | member 6 | | |
| 215783_s_at | ALPL | Hs.250769 | alkaline phosphatase, liver/bone/kidney | 1 | 30.5 |
| 216316_x_at | — | — | — | 0 | 72.65 |
| 216782_at | — | Hs.306863 | Homo sapiens cDNA: FLJ23026 fis, clone | 0 | 50.45 |
| | | | LNG01738 | | |
| 216985_s_at | STX3A | Hs.82240 | syntaxin 3A | 0 | 59.2 |
| 217104_at | LOC283687 | Hs.512015 | hypothetical protein LOC283687 | 1 | 27.45 |
| 217475_s_at | LIMK2 | Hs.278027 | LIM domain kinase 2 | 0 | 27.05 |
| 217502_at | IFIT2 | Hs.169274 | interferon-induced protein with | 0 | 109.9 |
| | | | tetratricopeptide repeats 2 | | |
| 217966_s_at | C1orf24 | Hs.48778 | chromosome 1 open reading frame 24 | 0 | 53.9 |
| 217967_s_at | C1orf24 | Hs.48778 | chromosome 1 open reading frame 24 | 0 | 68.6 |
| 218963_s_at | KRT23 | Hs.9029 | keratin 23 (histone deacetylase inducible) | 0 | 64 |
| 219313_at | DKFZp434C0328 | Hs.24583 | hypothetical protein DKFZp434C0328 | 0 | 42.3 |
| 220302_at | MAK | Hs.148496 | male germ cell-associated kinase | 0 | 63.6 |
| 220404_at | GPR97 | Hs.383403 | G protein-coupled receptor 97 | 1 | 79.95 |
| 220528_at | VNN3 | Hs.183656 | vanin 3 | 1 | 59.2 |
| 220603_s_at | FLJ11175 | Hs.33368 | hypothetical protein FLJ11175 | 0 | 55.4 |
| 221345_at | GPR43 | Hs.248056 | G protein-coupled receptor 43 | 1 | 42.5 |
| 221920_s_at | MSCP | Hs.283716 | mitochondrial solute carrier protein | 0 | 47.8 |
| 41469_at | PI3 | Hs.112341 | protease inhibitor 3, skin-derived (SKALP) | 0 | 39.4 |

TABLE 3
Selection Conditions for Cell-Type-Associated Marker Genes:

| | | Difference in the |
|---|---|---|
| Cell Type | Selectivity | Signals |
| CD4+ T Cells | 100% | 8-fold |
| Monocytes | 100% | 4-fold |
| Neutrophilic | 100% | 8-fold |
| Granulocytes | | |

TABLE 4

| | | | | |
|---|---|---|---|---|
| | | | | Normal |
| Donor | CD4+ T Cells | Monocytes | Granulocytes | Synovial Tissue |

A) Proportions of Various Cell Types in the Synovial Tissue
of RA Patients.

| | | | | |
|---|---|---|---|---|
| RA1 | 0.0470 | 0.0295 | 0.0092 | 0.9141 |
| RA2 | 0.0735 | 0.0751 | 0.0067 | 0.8445 |
| RA3 | 0.0096 | 0.0395 | 0.0100 | 0.9407 |
| RA4 | 0.0281 | 0.0364 | 0.0088 | 0.9265 |
| RA5 | 0.0268 | 0.0536 | 0.0087 | 0.9107 |
| RA6 | 0.0035 | 0.0393 | 0.0066 | 0.9503 |
| RA7 | 0.0113 | 0.0377 | 0.0085 | 0.9423 |
| RA8 | 0.0270 | 0.0340 | 0.0075 | 0.9313 |
| RA9 | 0.0192 | 0.0545 | 0.0093 | 0.9169 |
| RA10 | 0.0071 | 0.0404 | 0.0090 | 0.9432 |

B) Proportions of Various Cell Types in the Synovial Tissue
of OA Patients.

| | | | | |
|---|---|---|---|---|
| OA1 | 0.0006 | 0.0299 | 0.0073 | 0.9620 |
| OA2 | 0.0004 | 0.0562 | 0.0058 | 0.9374 |
| OA3 | 0.0016 | 0.0172 | 0.0067 | 0.9743 |
| OA4 | 0.0003 | 0.0226 | 0.0070 | 0.9698 |
| OA5 | 0.0016 | 0.0382 | 0.0078 | 0.9523 |
| OA6 | 0.0002 | 0.0262 | 0.0058 | 0.9675 |
| OA7 | 0.0013 | 0.0466 | 0.0076 | 0.9444 |
| OA8 | 0.0006 | 0.0353 | 0.0062 | 0.9577 |
| OA9 | 0.0018 | 0.0346 | 0.0058 | 0.9576 |
| OA10 | 0.0018 | 0.0259 | 0.0064 | 0.9657 |

TABLE 5
Genes Selected According to Infiltration Features under Condition 1.

| Affymetrix_ID | Gen Symbol | Unigene | Name |
|---|---|---|---|
| 202803_s_at | ITGB2 | Hs.375957 | integrin, beta 2 (antigen CD18 (p95), |
| | | | lymphocyte function-associated antigen 1; |
| | | | macrophage antigen 1 (mac-1) beta |
| | | | subunit) |
| 202833_s_at | SERPINA1 | Hs.297681 | serine (or cysteine) proteinase inhibitor, |
| | | | clade A (alpha-1 antiproteinase, |
| | | | antitrypsin), member 1 |
| 202855_s_at | SLC16A3 | Hs.386678 | solute carrier family 16 (monocarboxylic |
| | | | acid transporters), member 3 |
| 202917_s_at | S100A8 | Hs.416073 | S100 calcium binding protein A8 |
| | | | (calgranulin A) |
| 203047_at | STK10 | Hs.16134 | serine/threonine kinase 10 |
| 203281_s_at | UBE1L | Hs.16695 | ubiquitin-activating enzyme E1-like |
| 203388_at | ARRB2 | Hs.435811 | arrestin, beta 2 |
| 203485_at | RTN1 | Hs.99947 | reticulon 1 |
| 203528_at | SEMA4D | Hs.511748 | sema domain, immunoglobulin domain |
| | | | (Ig), transmembrane domain (TM) and |
| | | | short cytoplasmic domain, (semaphorin) |
| | | | 4D |
| 203535_at | S100A9 | Hs.112405 | S100 calcium binding protein A9 |
| | | | (calgranulin B) |
| 203828_s_at | NK4 | Hs.943 | natural killer cell transcript 4 |
| 204116_at | IL2RG | Hs.84 | interleukin 2 receptor, gamma (severe |
| | | | combined immunodeficiency) |
| 204118_at | CD48 | Hs.901 | CD48 antigen (B-cell membrane protein) |
| 204192_at | CD37 | Hs.153053 | CD37 antigen |
| 204198_s_at | RUNX3 | Hs.170019 | runt-related transcription factor 3 |
| 204220_at | GMFG | Hs.5210 | glia maturation factor, gamma |
| 204563_at | SELL | Hs.82848 | selectin L (lymphocyte adhesion molecule |
| | | | 1) |
| 204661_at | CDW52 | Hs.276770 | CDW52 antigen (CAMPATH-1 antigen) |
| 204698_at | ISG20 | Hs.105434 | interferon stimulated gene 20 kDa |
| 204860_s_at | — | Hs.508565 | Homo sapiens transcribed sequence with |
| | | | strong similarity to protein sp: Q13075 |
| | | | (H. sapiens) BIR1_HUMAN Baculoviral |
| | | | IAP repeat-containing protein 1 (Neuronal |
| | | | apoptosis inhibitory protein) |
| 204891_s_at | LCK | Hs.1765 | lymphocyte-specific protein tyrosine |
| | | | kinase |
| 204949_at | ICAM3 | Hs.353214 | intercellular adhesion molecule 3 |
| 204959_at | MNDA | Hs.153837 | myeloid cell nuclear differentiation antigen |
| 204960_at | PTPRCAP | Hs.155975 | protein tyrosine phosphatase, receptor |
| | | | type, C-associated protein |
| 204961_s_at | NCF1 | Hs.458275 | neutrophil cytosolic factor 1 (47 kDa, |
| | | | chronic granulomatous disease, autosomal |
| | | | 1) |
| 205174_s_at | QPCT | Hs.79033 | glutaminyl-peptide cyclotransferase |
| | | | (glutaminyl cyclase) |
| 205237_at | FCN1 | Hs.440898 | ficolin (collagen/fibrinogen domain |
| | | | containing) 1 |
| 205285_s_at | FYB | Hs.276506 | FYN binding protein (FYB-120/130) |
| 205312_at | SPI1 | Hs.157441 | spleen focus forming virus (SFFV) proviral |
| | | | integration oncogene spi1 |
| 205590_at | RASGRP1 | Hs.189527 | RAS guanyl releasing protein 1 (calcium |
| | | | and DAG-regulated) |
| 205639_at | AOAH | Hs.82542 | acyloxyacyl hydrolase (neutrophil) |
| 205681_at | BCL2A1 | Hs.227817 | BCL2-related protein A1 |
| 205798_at | IL7R | Hs.362807 | interleukin 7 receptor |
| 205831_at | CD2 | Hs.89476 | CD2 antigen (p50), sheep red blood cell |
| | | | receptor |
| 205885_s_at | ITGA4 | Hs.145140 | integrin, alpha 4 (antigen CD49D, alpha 4 |
| | | | subunit of VLA-4 receptor) |
| 205936_s_at | HK3 | Hs.411695 | hexokinase 3 (white cell) |
| 206011_at | CASP1 | Hs.2490 | caspase 1, apoptosis-related cysteine |
| | | | protease (interleukin 1, beta, convertase) |
| 206082_at | HCP5 | Hs.511759 | HLA complex P5 |
| 206296_x_at | MAP4K1 | Hs.95424 | mitogen-activated protein kinase kinase |
| | | | kinase kinase 1 |
| 206337_at | CCR7 | Hs.1652 | chemokine (C—C motif) receptor 7 |
| 206470_at | PLXNC1 | Hs.286229 | plexin C1 |
| 206925_at | SIAT8D | Hs.308628 | sialyltransferase 8D (alpha-2, 8- |
| | | | polysialyltransferase) |
| 206978_at | CCR2 | Hs.511794 | chemokine (C—C motif) receptor 2 |
| 207104_x_at | LILRB1 | Hs.149924 | leukocyte immunoglobulin-like receptor, |
| | | | subfamily B (with TM and ITIM domains), |
| | | | member 1 |
| 207238_s_at | PTPRC | Hs.444324 | protein tyrosine phosphatase, receptor |
| | | | type, C |
| 207339_s_at | LTB | Hs.376208 | lymphotoxin beta (TNF superfamily, |
| | | | member 3) |
| 207419_s_at | RAC2 | Hs.301175 | ras-related C3 botulinum toxin substrate 2 |
| | | | (rho family, small GTP binding protein |
| | | | Rac2) |
| 207522_s_at | ATP2A3 | Hs.5541 | ATPase, Ca++ transporting, ubiquitous |
| 207540_s_at | SYK | Hs.192182 | spleen tyrosine kinase |
| 207610_s_at | EMR2 | Hs.137354 | egf-like module containing, mucin-like, |
| | | | hormone receptor-like sequence 2 |
| 207677_s_at | NCF4 | Hs.196352 | neutrophil cytosolic factor 4, 40 kDa |
| 207697_x_at | LILRB2 | Hs.306230 | leukocyte immunoglobulin-like receptor, |
| | | | subfamily B (with TM and ITIM domains), |
| | | | member 2 |
| 208018_s_at | HCK | Hs.89555 | hemopoietic cell kinase |
| 208450_at | LGALS2 | Hs.113987 | lectin, galactoside-binding, soluble, 2 |
| | | | (galectin 2) |
| 208885_at | LCP1 | Hs.381099 | lymphocyte cytosolic protein 1 (L-plastin) |
| 209083_at | CORO1A | Hs.415067 | coronin, actin binding protein, 1A |
| 209201_x_at | CXCR4 | Hs.421986 | chemokine (C—X—C motif) receptor 4 |
| 209670_at | TRA@ | Hs.74647 | T cell receptor alpha locus |
| 209671_x_at | TRA@ | Hs.74647 | T cell receptor alpha locus |
| 209813_x_at | TRG@ | Hs.407442 | T cell receptor gamma locus |
| 209879_at | SELPLG | Hs.423077 | selectin P ligand |
| 209901_x_at | AIF1 | Hs.76364 | allograft inflammatory factor 1 |
| 209949_at | NCF2 | Hs.949 | neutrophil cytosolic factor 2 (65 kDa, |
| | | | chronic granulomatous disease, autosomal |
| | | | 2) |
| 210031_at | CD3Z | Hs.97087 | CD3Z antigen, zeta polypeptide (TiT3 |
| | | | complex) |
| 210116_at | SH2D1A | Hs.151544 | SH2 domain protein 1A, Duncan's disease |
| | | | (lymphoproliferative syndrome) |
| 210140_at | CST7 | Hs.143212 | cystatin F (leukocystatin) |
| 210146_x_at | LILRB2 | Hs.306230 | leukocyte immunoglobulin-like receptor, |
| | | | subfamily B (with TM and ITIM domains), |
| | | | member 2 |
| 210222_s_at | RTN1 | Hs.99947 | reticulon 1 |
| 210629_x_at | LST1 | Hs.436066 | leukocyte specific transcript 1 |
| 210895_s_at | CD86 | Hs.27954 | CD86 antigen (CD28 antigen ligand 2, B7- |
| | | | 2 antigen) |
| 210915_x_at | — | Hs.419777 | Homo sapiens T cell receptor beta chain |
| | | | BV20S1 BJ1-5 BC1 mRNA, complete cds |
| 210972_x_at | TRA@ | Hs.74647 | T cell receptor alpha locus |
| 210992_x_at | FCGR2A | Hs.352642 | Fc fragment of IgG, low affinity IIa, |
| | | | receptor for (CD32) |
| 211367_s_at | CASP1 | Hs.2490 | caspase 1, apoptosis-related cysteine |
| | | | protease (interleukin 1, beta, convertase) |
| 211368_s_at | CASP1 | Hs.2490 | caspase 1, apoptosis-related cysteine |
| | | | protease (interleukin 1, beta, convertase) |
| 211395_x_at | FCGR2B | Hs.126384 | Fc fragment of IgG, low affinity IIb, |
| | | | receptor for (CD32) |
| 211429_s_at | — | Hs.513816 | Homo sapiens PRO2275 mRNA, complete |
| | | | cds |
| 211581_x_at | LST1 | Hs.436066 | leukocyte specific transcript 1 |
| 211582_x_at | LST1 | Hs.436066 | leukocyte specific transcript 1 |
| 211742_s_at | EVI2B | Hs.5509 | ecotropic viral integration site 2B |
| 211795_s_at | FYB | Hs.276506 | FYN binding protein (FYB-120/130) |
| 211796_s_at | — | Hs.419777 | Homo sapiens T cell receptor beta chain |
| | | | BV20S1 BJ1-5 BC1 mRNA, complete cds |
| 211902_x_at | — | Hs.74647 | Homo sapiens T-cell receptor alpha chain |
| | | | (TCRA) mRNA |
| 212560_at | SORL1 | Hs.438159 | sortilin-related receptor, L(DLR class) A |
| | | | repeats-containing |
| 212587_s_at | PTPRC | Hs.444324 | protein tyrosine phosphatase, receptor |
| | | | type, C |
| 212613_at | BTN3A2 | Hs.376046 | butyrophilin, subfamily 3, member A2 |
| 212873_at | HA-1 | Hs.196914 | minor histocompatibility antigen HA-1 |
| 213095_x_at | AIF1 | Hs.76364 | allograft inflammatory factor 1 |
| 213193_x_at | — | Hs.419777 | Homo sapiens T cell receptor beta chain |
| | | | BV20S1 BJ1-5 BC1 mRNA, complete cds |
| 213309_at | PLCL2 | Hs.54886 | phospholipase C-like 2 |
| 213416_at | ITGA4 | Hs.145140 | integrin, alpha 4 (antigen CD49D, alpha 4 |
| | | | subunit of VLA-4 receptor) |
| 213475_s_at | ITGAL | Hs.174103 | integrin, alpha L (antigen CD11A (p180), |
| | | | lymphocyte function-associated antigen 1; |
| | | | alpha polypeptide) |
| 213539_at | CD3D | Hs.95327 | CD3D antigen, delta polypeptide (TiT3 |
| | | | complex) |
| 213603_s_at | RAC2 | Hs.301175 | ras-related C3 botulinum toxin substrate 2 |
| | | | (rho family, small GTP binding protein |
| | | | Rac2) |
| 213888_s_at | DJ434O14.3 | Hs.147434 | hypothetical protein dJ434O14.3 |
| 213915_at | NKG7 | Hs.10306 | natural killer cell group 7 sequence |
| 214084_x_at | — | Hs.448231 | Homo sapiens similar to neutrophil |
| | | | cytosolic factor 1 (47 kD, chronic |
| | | | granulomatous disease, autosomal 1) |
| | | | (LOC220830), mRNA |
| 214181_x_at | NCR3 | Hs.509513 | natural cytotoxicity triggering receptor 3 |
| 214366_s_at | ALOX5 | Hs.89499 | arachidonate 5-lipoxygenase |
| 214467_at | GPR65 | Hs.131924 | G protein-coupled receptor 65 |
| 214574_x_at | LST1 | Hs.436066 | leukocyte specific transcript 1 |
| 214617_at | PRF1 | Hs.2200 | perforin 1 (pore forming protein) |
| 215051_x_at | AIF1 | Hs.76364 | allograft inflammatory factor 1 |
| 215633_x_at | LST1 | Hs.436066 | leukocyte specific transcript 1 |
| 215806_x_at | TRG@ | Hs.385086 | T cell receptor gamma locus |
| 216920_s_at | TRG@ | Hs.385086 | T cell receptor gamma locus |
| 217147_s_at | TRIM | Hs.138701 | T-cell receptor interacting molecule |
| 217755_at | HN1 | Hs.109706 | hematological and neurological expressed 1 |
| 218231_at | NAGK | Hs.7036 | N-acetylglucosamine kinase |
| 218870_at | ARHGAP15 | Hs.433597 | Rho GTPase activating protein 15 |
| 219014_at | PLAC8 | Hs.371003 | placenta-specific 8 |
| 219191_s_at | BIN2 | Hs.14770 | bridging integrator 2 |
| 219279_at | DOCK10 | Hs.21126 | dedicator of cytokinesis protein 10 |
| 219403_s_at | HPSE | Hs.44227 | heparanase |
| 219452_at | DPEP2 | Hs.499331 | dipeptidase 2 |
| 219505_at | CECR1 | Hs.170310 | cat eye syndrome chromosome region, |
| | | | candidate 1 |
| 219788_at | PILRA | Hs.122591 | paired immunoglobin-like type 2 receptor |
| | | | alpha |
| 219812_at | STAG3 | Hs.323634 | stromal antigen 3 |
| 219947_at | CLECSF6 | Hs.115515 | C-type (calcium dependent, carbohydrate- |
| | | | recognition domain) lectin, superfamily |
| | | | member 6 |
| 220066_at | CARD15 | Hs.135201 | caspase recruitment domain family, |
| | | | member 15 |
| 221059_s_at | CHST6 | Hs.157439 | carbohydrate (N-acetylglucosamine 6-O) |
| | | | sulfotransferase 6 |
| 221081_s_at | FLJ22457 | Hs.447624 | hypothetical protein FLJ22457 |
| 221558_s_at | LEF1 | Hs.44865 | lymphoid enhancer-binding factor 1 |
| 221581_s_at | WBSCR5 | Hs.56607 | Williams-Beuren syndrome chromosome |
| | | | region 5 |
| 221601_s_at | TOSO | Hs.58831 | regulator of Fas-induced apoptosis |
| 222062_at | WSX1 | Hs.132781 | class I cytokine receptor |
| 222218_s_at | PILRA | Hs.122591 | paired immunoglobin-like type 2 receptor |
| | | | alpha |
| 34210_at | CDW52 | Hs.276770 | CDW52 antigen (CAMPATH-1 antigen) |
| 35974_at | LRMP | Hs.124922 | lymphoid-restricted membrane protein |

TABLE 6
Genes selected according to features under Condition 2. The genes labeled 1 in the
last column represent other multiple determinations of immunoglobulin sequences in
addition to selected representatives and were therefore not used for the statistical
calculations and cluster analysis in the related figures.

| Affymetrix_ID | Gen Symbol | Unigene | Name |
|---|---|---|---|
| 200887_s_at | STAT1 | Hs.21486 | signal transducer and activator of |
| | | | transcription 1, 91 kDa |
| 201137_s_at | HLA-DPB1 | Hs.368409 | major histocompatibility complex, class II, |
| | | | DP beta 1 |
| 201286_at | SDC1 | Hs.82109 | syndecan 1 |
| 201287_s_at | SDC1 | Hs.82109 | syndecan 1 |
| 201291_s_at | TOP2A | Hs.156346 | topoisomerase (DNA) II alpha 170 kDa |
| 201310_s_at | C5orf13 | Hs.508741 | chromosome 5 open reading frame 13 |
| 201668_x_at | MARCKS | Hs.318603 | myristoylated alanine-rich protein kinase C |
| | | | substrate |
| 201669_s_at | MARCKS | Hs.318603 | myristoylated alanine-rich protein kinase C |
| | | | substrate |
| 201670_s_at | MARCKS | Hs.318603 | myristoylated alanine-rich protein kinase C |
| | | | substrate |
| 201688_s_at | TPD52 | Hs.162089 | tumor protein D52 |
| 201689_s_at | TPD52 | Hs.162089 | tumor protein D52 |
| 201690_s_at | TPD52 | Hs.162089 | tumor protein D52 |
| 201852_x_at | COL3A1 | Hs.443625 | collagen, type III, alpha 1 (Ehlers-Danlos |
| | | | syndrome type IV, autosomal dominant) |
| 201890_at | RRM2 | Hs.226390 | ribonucleotide reductase M2 polypeptide |
| 202269_x_at | GBP1 | Hs.62661 | guanylate binding protein 1, interferon- |
| | | | inducible, 67 kDa |
| 202270_at | GBP1 | Hs.62661 | guanylate binding protein 1, interferon- |
| | | | inducible, 67 kDa |
| 202310_s_at | COL1A1 | Hs.172928 | collagen, type I, alpha 1 |
| 202311_s_at | COL1A1 | Hs.172928 | collagen, type I, alpha 1 |
| 202404_s_at | COL1A2 | Hs.232115 | collagen, type I, alpha 2 |
| 202411_at | IFI27 | Hs.278613 | interferon, alpha-inducible protein 27 |
| 202898_at | SDC3 | Hs.158287 | syndecan 3 (N-syndecan) |
| 202998_s_at | LOXL2 | Hs.83354 | lysyl oxidase-like 2 |
| 203213_at | CDC2 | Hs.334562 | cell division cycle 2, G1 to S and G2 to M |
| 203232_s_at | SCA1 | Hs.434961 | spinocerebellar ataxia 1 |
| | | | (olivopontocerebellar ataxia 1, autosomal |
| | | | dominant, ataxin 1) |
| 203325_s_at | COL5A1 | Hs.433695 | collagen, type V, alpha 1 |
| 203417_at | MFAP2 | Hs.389137 | microfibrillar-associated protein 2 |
| 203570_at | LOXL1 | Hs.65436 | lysyl oxidase-like 1 |
| 203666_at | CXCL12 | Hs.436042 | chemokine (C—X—C motif) ligand 12 |
| | | | (stromal cell-derived factor 1) |
| 203868_s_at | VCAM1 | Hs.109225 | vascular cell adhesion molecule 1 |
| 203915_at | CXCL9 | Hs.77367 | chemokine (C—X—C motif) ligand 9 |
| 203917_at | CXADR | Hs.79187 | coxsackie virus and adenovirus receptor |
| 203932_at | HLA-DMB | Hs.1162 | major histocompatibility complex, class II, |
| | | | DM beta |
| 204051_s_at | SFRP4 | Hs.105700 | secreted frizzled-related protein 4 |
| 204114_at | NID2 | Hs.147697 | nidogen 2 (osteonidogen) |
| 204358_s_at | FLRT2 | Hs.48998 | fibronectin leucine rich transmembrane |
| | | | protein 2 |
| 204359_at | FLRT2 | Hs.48998 | fibronectin leucine rich transmembrane |
| | | | protein 2 |
| 204470_at | CXCL1 | Hs.789 | chemokine (C—X—C motif) ligand 1 |
| | | | (melanoma growth stimulating activity, |
| | | | alpha) |
| 204471_at | GAP43 | Hs.79000 | growth associated protein 43 |
| 204475_at | MMP1 | Hs.83169 | matrix metalloproteinase 1 (interstitial |
| | | | collagenase) |
| 204533_at | CXCL10 | Hs.413924 | chemokine (C—X—C motif) ligand 10 |
| 204670_x_at | HLA-DRB3 | Hs.308026 | major histocompatibility complex, class II, |
| | | | DR beta 3 |
| 205049_s_at | CD79A | Hs.79630 | CD79A antigen (immunoglobulin- |
| | | | associated alpha) |
| 205081_at | CRIP1 | Hs.423190 | cysteine-rich protein 1 (intestinal) |
| 205234_at | SLC16A4 | Hs.351306 | solute carrier family 16 (monocarboxylic |
| | | | acid transporters), member 4 |
| 205242_at | CXC L13 | Hs.100431 | chemokine (C—X—C motif) ligand 13 (B-cell |
| | | | chemoattractant) |
| 205267_at | POU2AF1 | Hs.2407 | POU domain, class 2, associating factor 1 |
| 205569_at | LAMP3 | Hs.10887 | lysosomal-associated membrane protein 3 |
| 205671_s_at | HLA-DOB | Hs.1802 | major histocompatibility complex, class II, |
| | | | DO beta |
| 205692_s_at | CD38 | Hs.174944 | CD38 antigen (p45) |
| 205721_at | GFRA2 | Hs.441202 | GDNF family receptor alpha 2 |
| 205801_s_at | RASGRP3 | Hs.24024 | RAS guanyl releasing protein 3 (calcium |
| | | | and DAG-regulated) |
| 205819_at | MARCO | Hs.67726 | macrophage receptor with collagenous |
| | | | structure |
| 205828_at | MMP3 | Hs.375129 | matrix metalloproteinase 3 (stromelysin 1, |
| | | | progelatinase) |
| 205890_s_at | UBD | Hs.44532 | ubiquitin D |
| 205997_at | ADAM28 | Hs.174030 | a disintegrin and metalloproteinase domain |
| | | | 28 |
| 206022_at | NDP | Hs.2839 | Norrie disease (pseudoglioma) |
| 206025_s_at | TNFAIP6 | Hs.407546 | tumor necrosis factor, alpha-induced |
| | | | protein 6 |
| 206026_s_at | TNFAIP6 | Hs.407546 | tumor necrosis factor, alpha-induced |
| | | | protein 6 |
| 206134_at | ADAMDEC1 | Hs.145296 | ADAM-like, decysin 1 |
| 206206_at | LY64 | Hs.87205 | lymphocyte antigen 64 homolog, |
| | | | radioprotective 105 kDa (mouse) |
| 206313_at | HLA-DOA | Hs.351874 | major histocompatibility complex, class II, |
| | | | DO alpha |
| 206336_at | CXCL6 | Hs.164021 | chemokine (C—X—C motif) ligand 6 |
| | | | (granulocyte chemotactic protein 2) |
| 206366_x_at | XCL1 | Hs.174228 | chemokine (C motif) ligand 1 |
| 206407_s_at | CCL13 | Hs.414629 | chemokine (C—C motif) ligand 13 |
| 206513_at | AIM2 | Hs.105115 | absent in melanoma 2 |
| 206641_at | TNFRSF17 | Hs.2556 | tumor necrosis factor receptor superfamily, |
| | | | member 17 |
| 206682_at | CLECSF13 | Hs.54403 | C-type (calcium dependent, carbohydrate- |
| | | | recognition domain) lectin, superfamily |
| | | | member 13 (macrophage-derived) |
| 207173_x_at | CDH11 | Hs.443435 | cadherin 11, type 2, OB-cadherin |
| | | | (osteoblast) |
| 207655_s_at | BLNK | Hs.167746 | B-cell linker |
| 207714_s_at | SERPINH1 | Hs.241579 | serine (or cysteine) proteinase inhibitor, |
| | | | clade H (heat shock protein 47), member 1, |
| | | | (collagen binding protein 1) |
| 207977_s_at | DPT | Hs.80552 | dermatopontin |
| 208091_s_at | DKFZP564K0822 | Hs.4750 | hypothetical protein DKFZp564K0822 |
| 208161_s_at | ABCC3 | Hs.90786 | ATP-binding cassette, sub-family C |
| | | | (CFTR/MRP), member 3 |
| 208850_s_at | THY1 | Hs.134643 | Thy-1 cell surface antigen |
| 208851_s_at | THY1 | Hs.134643 | Thy-1 cell surface antigen |
| 208894_at | HLA-DRA | Hs.409805 | major histocompatibility complex, class II, |
| | | | DR alpha |
| 208906_at | BSCL2 | Hs.438912 | Bernardinelli-Seip congenital lipodystrophy |
| | | | 2 (seipin) |
| 209138_x_at | IGL@ | Hs.458262 | immunoglobulin lambda locus 1 |
| 209267_s_at | BIGM103 | Hs.284205 | BCG-induced gene in monocytes, clone |
| | | | 103 |
| 209312_x_at | HLA-DRB3 | Hs.308026 | major histocompatibility complex, class II, |
| | | | DR beta 3 |
| 209374_s_at | IGHM | Hs.439852 | immunoglobulin heavy constant mu 1 |
| 209496_at | RARRES2 | Hs.37682 | retinoic acid receptor responder (tazarotene |
| | | | induced) 2 |
| 209546_s_at | APOL1 | Hs.114309 | apolipoprotein L, 1 |
| 209583_s_at | MOX2 | Hs.79015 | antigen identified by monoclonal antibody |
| | | | MRC OX-2 |
| 209596_at | DKFZp564I1922 | Hs.72157 | adlican |
| 209619_at | CD74 | Hs.446471 | CD74 antigen (invariant polypeptide of |
| | | | major histocompatibility complex, class II |
| | | | antigen-associated) |
| 209627_s_at | OSBPL3 | Hs.197955 | oxysterol binding protein-like 3 |
| 209696_at | FBP1 | Hs.360509 | fructose-1,6-bisphosphatase 1 |
| 209875_s_at | SPP1 | Hs.313 | secreted phosphoprotein 1 (osteopontin, |
| | | | bone sialoprotein I, early T-lymphocyte |
| | | | activation 1) |
| 209906_at | C3AR1 | Hs.155935 | complement component 3a receptor 1 |
| 209924_at | CCL18 | Hs.16530 | chemokine (C—C motif) ligand 18 |
| | | | (pulmonary and activation-regulated) |
| 209946_at | VEGFC | Hs.79141 | vascular endothelial growth factor C |
| 209955_s_at | FAP | Hs.436852 | fibroblast activation protein, alpha |
| 210072_at | CCL19 | Hs.50002 | chemokine (C—C motif) ligand 19 |
| 210152_at | LILRB4 | Hs.67846 | leukocyte immunoglobulin-like receptor, |
| | | | subfamily B (with TM and ITIM domains), |
| | | | member 4 |
| 210163_at | CXCL11 | Hs.103982 | chemokine (C—X—C motif) ligand 11 |
| 210356_x_at | MS4A1 | Hs.438040 | membrane-spanning 4-domains, subfamily |
| | | | A, member 1 |
| 210643_at | TNFSF11 | Hs.333791 | tumor necrosis factor (ligand) superfamily, |
| | | | member 11 |
| 210889_s_at | FCGR2B | Hs.126384 | Fc fragment of IgG, low affinity IIb, |
| | | | receptor for (CD32) |
| 211122_s_at | CXCL11 | Hs.103982 | chemokine (C—X—C motif) ligand 11 |
| 211161_s_at | — | Hs.119571 | collagen, type III, alpha 1 (Ehlers-Danlos |
| | | | syndrome type IV, autosomal dominant) |
| 211430_s_at | IGHG3 | Hs.413826 | immunoglobulin heavy constant gamma 3 |
| | | | (G3m marker) |
| 211633_x_at | — | Hs.406615 | Homo sapiens clone P2-114 anti-oxidized 1 |
| | | | LDL immunoglobulin heavy chain Fab |
| | | | mRNA, partial cds |
| 211634_x_at | — | Hs.449011 | Homo sapiens partial mRNA for 1 |
| | | | immunoglobulin heavy chain variable |
| | | | region (IGHV gene), isolate B-CLL G026 |
| 211635_x_at | — | Hs.449011 | Homo sapiens partial mRNA for 1 |
| | | | immunoglobulin heavy chain variable |
| | | | region (IGHV gene), isolate B-CLL G026 |
| 211637_x_at | — | Hs.383169 | Homo sapiens partial mRNA for 1 |
| | | | immunoglobulin heavy chain variable |
| | | | region (IGHV32-D-JH-Cmu gene), clone |
| | | | ET39 |
| 211639_x_at | — | Hs.383438 | Homo sapiens clone HA1 anti-HAV capsid 1 |
| | | | immunoglobulin G heavy chain variable |
| | | | region mRNA, partial cds |
| 211640_x_at | — | Hs.449011 | Homo sapiens partial mRNA for 1 |
| | | | immunoglobulin heavy chain variable |
| | | | region (IGHV gene), isolate B-CLL G026 |
| 211641_x_at | — | Hs.64568 | Homo sapiens clone P2-116 anti-oxidized 1 |
| | | | LDL immunoglobulin heavy chain Fab |
| | | | mRNA, partial cds |
| 211643_x_at | — | Hs.512126 | Homo sapiens clone P2-32 anti-oxidized 1 |
| | | | LDL immunoglobulin light chain Fab |
| | | | mRNA, partial cds |
| 211644_x_at | — | Hs.512125 | Homo sapiens clone H2-38 anti-oxidized |
| | | | LDL immunoglobulin light chain Fab |
| | | | mRNA, partial cds |
| 211645_x_at | — | Hs.512133 | Homo sapiens isolate donor Z clone Z55K 1 |
| | | | immunoglobulin kappa light chain variable |
| | | | region mRNA, partial cds |
| 211647_x_at | — | Hs.449057 | Homo sapiens partial mRNA for 1 |
| | | | immunoglobulin heavy chain variable |
| | | | region (IGHV gene), case 1, variant tumor |
| | | | clone 5 |
| 211649_x_at | — | Hs.449057 | Homo sapiens partial mRNA for 1 |
| | | | immunoglobulin heavy chain variable |
| | | | region (IGHV gene), case 1, variant tumor |
| | | | clone 5 |
| 211650_x_at | — | Hs.448957 | Homo sapiens partial mRNA for IgM 1 |
| | | | immunoglobulin heavy chain variable |
| | | | region (IGHV gene), clone LIBPM376 |
| 211654_x_at | HLA-DQB1 | Hs.409934 | major histocompatibility complex, class II, |
| | | | DQ beta 1 |
| 211655_at | — | Hs.405944 | Homo sapiens cDNA clone MGC: 62026 1 |
| | | | IMAGE: 6450688, complete cds |
| 211656_x_at | HLA-DQB1 | Hs.409934 | major histocompatibility complex, class II, |
| | | | DQ beta 1 |
| 211798_x_at | IGLJ3 | Hs.102950 | immunoglobulin lambda joining 3 1 |
| 211835_at | — | Hs.159386 | Homo sapiens mRNA for single-chain 1 |
| | | | antibody, complete cds (scFv2) |
| 211868_x_at | — | Hs.249245 | Homo sapiens mRNA for single-chain 1 |
| | | | antibody, complete cds. |
| 211881_x_at | IGLJ3 | Hs.102950 | immunoglobulin lambda joining 3 1 |
| 211908_x_at | — | Hs.448957 | Homo sapiens partial mRNA for IgM 1 |
| | | | immunoglobulin heavy chain variable |
| | | | region (IGHV gene), clone LIBPM376 |
| 211990_at | HLA-DPA1 | Hs.914 | major histocompatibility complex, class II, |
| | | | DP alpha 1 |
| 211991_s_at | HLA-DPA1 | Hs.914 | major histocompatibility complex, class II, |
| | | | DP alpha 1 |
| 212311_at | KIAA0746 | Hs.49500 | KIAA0746 protein |
| 212314_at | KIAA0746 | Hs.49500 | KIAA0746 protein |
| 212488_at | COL5A1 | Hs.433695 | collagen, type V, alpha 1 |
| 212489_at | COL5A1 | Hs.433695 | collagen, type V, alpha 1 |
| 212592_at | IGJ | Hs.381568 | immunoglobulin J polypeptide, linker 1 |
| | | | protein for immunoglobulin alpha and mu |
| | | | polypeptides |
| 212624_s_at | CHN1 | Hs.380138 | chimerin (chimaerin) 1 |
| 212651_at | RHOBTB1 | Hs.15099 | Rho-related BTB domain containing 1 |
| 212671_s_at | HLA-DQA1 | Hs.387679 | major histocompatibility complex, class II, |
| | | | DQ alpha 1 |
| 212827_at | IGHM | Hs.439852 | immunoglobulin heavy constant mu 1 |
| 212942_s_at | KIAA1199 | Hs.212584 | KIAA1199 protein |
| 213056_at | GRSP1 | Hs.158867 | GRP1-binding protein GRSP1 |
| 213068_at | DPT | Hs.80552 | dermatopontin |
| 213125_at | DKFZP586L151 | Hs.43658 | DKFZP586L151 protein |
| 213502_x_at | — | Hs.272302 | Homo sapiens , clone IMAGE: 5728597, |
| | | | mRNA |
| 213537_at | HLA-DPA1 | Hs.914 | major histocompatibility complex, class II, |
| | | | DP alpha 1 |
| 213592_at | AGTRL1 | Hs.438311 | angiotensin II receptor-like 1 |
| 213869_x_at | THY1 | Hs.134643 | Thy-1 cell surface antigen |
| 213909_at | LRRC15 | Hs.288467 | leucine rich repeat containing 15 |
| 213975_s_at | LYZ | Hs.234734 | lysozyme (renal amyloidosis) |
| 214560_at | FPRL2 | Hs.511953 | formyl peptide receptor-like 2 |
| 214567_s_at | XCL2 | Hs.458346 | chemokine (C motif) ligand 2 |
| 214669_x_at | — | Hs.512125 | Homo sapiens clone H2-38 anti-oxidized 1 |
| | | | LDL immunoglobulin light chain Fab |
| | | | mRNA, partial cds |
| 214677_x_at | IGLJ3 | Hs.449601 | immunoglobulin lambda joining 3 1 |
| 214702_at | FN1 | Hs.418138 | fibronectin 1 |
| 214768_x_at | — | Hs.449610 | Homo sapiens clone RI-34 thyroid 1 |
| | | | peroxidase autoantibody light chain |
| | | | variable region mRNA, partial cds |
| 214770_at | MSR1 | Hs.436887 | macrophage scavenger receptor 1 |
| 214777_at | — | Hs.512124 | Homo sapiens immunoglobulin kappa light 1 |
| | | | chain VKJ region mRNA, partial cds |
| 214836_x_at | — | Hs.449610 | Homo sapiens clone RI-34 thyroid 1 |
| | | | peroxidase autoantibody light chain |
| | | | variable region mRNA, partial cds |
| 214916_x_at | — | Hs.448957 | Homo sapiens partial mRNA for IgM 1 |
| | | | immunoglobulin heavy chain variable |
| | | | region (IGHV gene), clone LIBPM376 |
| 214973_x_at | — | Hs.448982 | Homo sapiens isolate sy-3M/11-B4 1 |
| | | | immunoglobulin heavy chain variable |
| | | | region mRNA, partial cds. |
| 214974_x_at | CXCL5 | Hs.89714 | chemokine (C—X—C motif) ligand 5 |
| 215076_s_at | COL3A1 | Hs.443625 | collagen, type III, alpha 1 (Ehlers-Danlos |
| | | | syndrome type IV, autosomal dominant) |
| 215121_x_at | — | Hs.356861 | Homo sapiens cDNA FLJ26905 fis, clone 1 |
| | | | RCT01427, highly similar to Ig lambda |
| | | | chain C regions |
| 215176_x_at | — | Hs.503443 | Homo sapiens immunoglobulin kappa light 1 |
| | | | chain variable and constant region mRNA, |
| | | | partial cds |
| 215193_x_at | HLA-DRB3 | Hs.308026 | major histocompatibility complex, class II, |
| | | | DR beta 3 |
| 215214_at | — | Hs.449579 | Homo sapiens clone ASPBLL54 1 |
| | | | immunoglobulin lambda light chain VJ |
| | | | region mRNA, partial cds |
| 215536_at | HLA-DQB2 | Hs.375115 | major histocompatibility complex, class II, |
| | | | DQ beta 2 |
| 215565_at | — | Hs.467914 | Homo sapiens cDNA FLJ12215 fis, clone |
| | | | MAMMA1001021. |
| 215777_at | — | Hs.449575 | Homo sapiens clone mcg53-54 1 |
| | | | immunoglobulin lambda light chain |
| | | | variable region 4a mRNA, partial cds |
| 215946_x_at | — | Hs.272302 | Homo sapiens , clone IMAGE: 5728597, |
| | | | mRNA |
| 215949_x_at | — | Hs.1349 | colony stimulating factor 2 (granulocyte-1 |
| | | | macrophage) |
| 216207_x_at | IGKV1D-13 | Hs.390427 | immunoglobulin kappa variable 1D-13 1 |
| 216365_x_at | — | Hs.283876 | Homo sapiens clone bsmneg3-t7 1 |
| | | | immunoglobulin lambda light chain VJ |
| | | | region, (IGL) mRNA, partial cds. |
| 216401_x_at | — | Hs.307136 | Homo sapiens partial IGKV gene for 1 |
| | | | immunoglobulin kappa chain variable |
| | | | region, clone 38 |
| 216412_x_at | — | Hs.449599 | Homo sapiens immunoglobulin lambda 1 |
| | | | light chain variable and constant region |
| | | | mRNA, partial cds |
| 216430_x_at | IGLJ3 | Hs.449601 | immunoglobulin lambda joining 3 1 |
| 216491_x_at | — | Hs.288711 | Human immunoglobulin heavy chain 1 |
| | | | variable region (V4-4) gene, partial cds |
| 216510_x_at | — | Hs.301365 | Homo sapiens IgH VH gene for 1 |
| | | | immunoglobulin heavy chain, partial cds |
| 216517_at | — | Hs.283770 | Human germline gene for the leader 1 |
| | | | peptide and variable region of a kappa |
| | | | immunoglobulin (subgroup V kappa I) |
| 216541_x_at | — | Hs.272359 | Homo sapiens partial IGVH1 gene for 1 |
| | | | immunoglobulin heavy chain V region, |
| | | | case 1, cell Mo V 94 |
| 216542_x_at | — | Hs.272355 | Homo sapiens partial IGVH3 V3-20 gene 1 |
| | | | for immunoglobulin heavy chain V region, |
| | | | case 1, clone 2 |
| 216557_x_at | — | Hs.249245 | Human rearranged immunoglobulin heavy 1 |
| | | | chain (A1VH3) gene, partial cds |
| 216560_x_at | — | Hs.249208 | Homo sapiens immunoglobulin lambda 1 |
| | | | gene locus DNA, clone: 84E4 |
| 216573_at | — | Hs.449596 | H. sapiens mRNA for Ig light chain, 1 |
| | | | variable region (ID: CLL001VL) |
| 216576_x_at | — | Hs.512131 | Homo sapiens clone H10 anti-HLA-1 |
| | | | A2/A28 immunoglobulin light chain |
| | | | variable region mRNA, partial cds |
| 216829_at | — | Hs.512131 | Homo sapiens clone H10 anti-HLA-1 |
| | | | A2/A28 immunoglobulin light chain |
| | | | variable region mRNA, partial cds |
| 216853_x_at | IGLJ3 | Hs.102950 | immunoglobulin lambda joining 3 1 |
| 216984_x_at | IGLJ3 | Hs.449592 | immunoglobulin lambda joining 3 1 |
| 217084_at | — | Hs.448876 | Homo sapiens partial mRNA for IgM 1 |
| | | | immunoglobulin heavy chain variable |
| | | | region (IGHV gene), clone LIBPM327 |
| 217148_x_at | IGLJ3 | Hs.449592 | immunoglobulin lambda joining 3 1 |
| 217157_x_at | — | Hs.449620 | Homo sapiens isolate donor N clone N8K 1 |
| | | | immunoglobulin kappa light chain variable |
| | | | region mRNA, partial cds |
| 217179_x_at | — | Hs.440830 | H. sapiens (T1.1) mRNA for IG lambda 1 |
| | | | light chain |
| 217198_x_at | — | Hs.247989 | Human immunoglobulin heavy chain 1 |
| | | | variable region (V4-30.2) gene, partial cds |
| 217227_x_at | — | Hs.449598 | Homo sapiens clone P2-114 anti-oxidized 1 |
| | | | LDL immunoglobulin light chain Fab |
| | | | mRNA, partial cds |
| 217235_x_at | — | Hs.449593 | Immunoglobulin light chain lambda 1 |
| | | | variable region [Homo sapiens ], mRNA |
| | | | sequence |
| 217258_x_at | — | Hs.449599 | Homo sapiens immunoglobulin lambda 1 |
| | | | light chain variable and constant region |
| | | | mRNA, partial cds |
| 217281_x_at | — | Hs.448987 | Homo sapiens mRNA for immunoglobulin 1 |
| | | | heavy chain variable region, ID 31 |
| 217320_at | — | Hs.512023 | Homo sapiens sequence ra34b-4G14 1 |
| | | | immunoglobulin heavy chain variable |
| | | | region mRNA, partial cds. |
| 217360_x_at | — | Hs.272363 | Homo sapiens partial IGVH3 gene for 1 |
| | | | immunoglobulin heavy chain V region, |
| | | | case 1, cell Mo VI 162 |
| 217362_x_at | H7LA-DRB3 | Hs.308026 | major histocompatibility complex, class II, |
| | | | DR beta 3 |
| 217369_at | — | Hs.272358 | Homo sapiens partial IGVH3 gene for 1 |
| | | | immunoglobulin heavy chain V region, |
| | | | case 1, cell Mo IV 72 |
| 217378_x_at | — | Hs.247804 | Human V108 gene encoding an 1 |
| | | | immunoglobulin kappa orphon |
| 217384_x_at | — | Hs.272357 | Homo sapiens partial IGVH3 gene for 1 |
| | | | immunoglobulin heavy chain V region, |
| | | | case 1, clone 19 |
| 217388_s_at | KYNU | Hs.444471 | kynureninase (L-kynurenine hydrolase) |
| 217418_x_at | MS4A1 | Hs.438040 | membrane-spanning 4-domains, subfamily |
| | | | A, member 1 |
| 217430_x_at | — | Hs.172928 | Homo sapiens mRNA for chimaeric |
| | | | transcript of collagen type 1 alpha 1 and |
| | | | platelet-derived growth factor beta, 189 bp. |
| 217478_s_at | HLA-DMA | Hs.351279 | major histocompatibility complex, class II, |
| | | | DM alpha |
| 217480_x_at | — | Hs.278448 | Human kappa-immunoglobulin germline 1 |
| | | | pseudogene (cos118) variable region |
| | | | (subgroup V kappa I) |
| 217771_at | GOLPH2 | Hs.352662 | golgi phosphoprotein 2 |
| 217853_at | TENS1 | Hs.12210 | tensin-like SH2 domain-containing 1 |
| 218730_s_at | OGN | Hs.109439 | osteoglycin (osteoinductive factor, |
| | | | mimecan) |
| 218815_s_at | FLJ10199 | Hs.30925 | hypothetical protein FLJ10199 |
| 218876_at | CGI-38 | Hs.412685 | brain specific protein |
| 219087_at | ASPN | Hs.435655 | asporin (LRR class 1) |
| 219117_s_at | FKBP11 | Hs.438695 | FK506 binding protein 11, 19 kDa |
| 219118_at | FKBP11 | Hs.438695 | FK506 binding protein 11, 19 kDa |
| 219159_s_at | CRACC | Hs.132906 | 19A24 protein |
| 219385_at | BLAME | Hs.438683 | B lymphocyte activator macrophage |
| | | | expressed |
| 219386_s_at | BLAME | Hs.438683 | B lymphocyte activator macrophage |
| | | | expressed |
| 219519_s_at | SN | Hs.31869 | sialoadhesin |
| 219667_s_at | BANK | Hs.193736 | B-cell scaffold protein with ankyrin repeats |
| 219696_at | FLJ20054 | Hs.101590 | hypothetical protein FLJ20054 |
| 219725_at | TREM2 | Hs.435295 | triggering receptor expressed on myeloid |
| | | | cells 2 |
| 219799_s_at | RDHL | Hs.179608 | NADP-dependent retinol |
| | | | dehydrogenase/reductase |
| 219869_s_at | BIGM103 | Hs.284205 | BCG-induced gene in monocytes, clone |
| | | | 103 |
| 219874_at | SLC12A8 | Hs.36793 | solute carrier family 12 (potassium/chloride |
| | | | transporters), member 8 |
| 219888_at | SPAG4 | Hs.123159 | sperm associated antigen 4 |
| 220076_at | ANKH | Hs.156727 | ankylosis, progressive homolog (mouse) |
| 220146_at | TLR7 | Hs.179152 | toll-like receptor 7 |
| 220423_at | PLA2G2D | Hs.189507 | phospholipase A2, group IID |
| 220532_s_at | LR8 | Hs.190161 | LR8 protein |
| 220918_at | RUNX1 | Hs.410774 | runt-related transcription factor 1 (acute |
| | | | myeloid leukemia 1; aml1 oncogene) |
| 221045_s_at | PER3 | Hs.418036 | period homolog 3 (Drosophila) |
| 221085_at | TNFSF15 | Hs.241382 | tumor necrosis factor (ligand) superfamily, |
| | | | member 15 |
| 221286_s_at | PACAP | Hs.409563 | proapoptotic caspase adaptor protein |
| 221538_s_at | DKFZp564A176 | Hs.432329 | hypothetical protein DKFZp564A176 |
| 221651_x_at | IGKC | Hs.377975 | immunoglobulin kappa constant 1 |
| 221730_at | COL5A2 | Hs.283393 | collagen, type V, alpha 2 |
| 221933_at | NLGN4 | Hs.21107 | neuroligin 4 |
| 222288_at | — | Hs.130526 | Homo sapiens transcribed sequence with |
| | | | weak similarity to protein ref: NP_060312.1 |
| | | | (H. sapiens) hypothetical protein FLJ20489 |
| | | | [Homo sapiens] |
| 32128_at | CCL18 | Hs.16530 | chemokine (C—C motif) ligand 18 |
| | | | (pulmonary and activation-regulated) |
| 37170_at | BMP2K | Hs.20137 | BMP2 inducible kinase |
| 59644_at | BMP2K | Hs.20137 | BMP2 inducible kinase |

TABLE 7
Genes Selected According to Features as Described under Example Condition 3.

| Affymetrix_ID | Gen Symbol | Unigene | Name |
|---|---|---|---|
| 1405_i_at | CCL5 | Hs.489044 | chemokine (C-C motif) ligand 5 |
| 201411_s_at | PLEKHB2 | Hs.307033 | pleckstrin homology domain containing, |
| | | | family B (evectins) member 2 |
| 201422_at | IFI30 | Hs.14623 | interferon, gamma-inducible protein 30 |
| 201720_s_at | LAPTM5 | Hs.436200 | Lysosomal-associated multispanning |
| | | | membrane protein-5 |
| 201743_at | CD14 | Hs.75627 | CD14 antigen |
| 201850_at | CAPG | Hs.82422 | capping protein (actin filament), gelsolin- |
| | | | like |
| 201998_at | SIAT1 | Hs.2554 | sialyltransferase 1 (beta-galactoside alpha- |
| | | | 2,6-sialyltransferase) |
| 202329_at | CSK | Hs.77793 | c-src tyrosine kinase |
| 202546_at | VAMP8 | Hs.172684 | vesicle-associated membrane protein 8 |
| | | | (endobrevin) |
| 202856_s_at | SLC16A3 | Hs.386678 | solute carrier family 16 (monocarboxylic |
| | | | acid transporters), member 3 |
| 202869_at | OAS1 | Hs.442936 | 2′,5′-oligoadenylate synthetase 1, 40/46 kDa |
| 202901_x_at | CTSS | Hs.181301 | cathepsin S |
| 202902_s_at | CTSS | Hs.181301 | cathepsin S |
| 202906_s_at | NBS1 | Hs.25812 | Nijmegen breakage syndrome 1 (nibrin) |
| 203028_s_at | CYBA | Hs.68877 | cytochrome b-245, alpha polypeptide |
| 203104_at | CSF1R | Hs.174142 | colony stimulating factor 1 receptor, |
| | | | formerly McDonough feline sarcoma viral |
| | | | (v-fms) oncogene homolog |
| 203148_s_at | TRIM14 | Hs.370530 | tripartite motif-containing 14 |
| 203153_at | IFIT1 | Hs.20315 | interferon-induced protein with |
| | | | tetratricopeptide repeats 1 |
| 203231_s_at | SCA1 | Hs.434961 | spinocerebellar ataxia 1 |
| | | | (olivopontocerebellar ataxia 1, autosomal |
| | | | dominant, ataxin 1) |
| 203471_s_at | PLEK | Hs.77436 | pleckstrin |
| 203561_at | FCGR2A | Hs.352642 | Fc fragment of IgG, low affinity IIa, |
| | | | receptor for (CD32) |
| 203625_x_at | SKP2 | Hs.23348 | S-phase kinase-associated protein 2 (p45) |
| 203741_s_at | ADCY7 | Hs.172199 | adenylate cyclase 7 |
| 203771_s_at | BLVRA | Hs.435726 | biliverdin reductase A |
| 203922_s_at | CYBB | Hs.88974 | cytochrome b-245, beta polypeptide |
| | | | (chronic granulomatous disease) |
| 203923_s_at | CYBB | Hs.88974 | cytochrome b-245, beta polypeptide |
| | | | (chronic granulomatous disease) |
| 203936_s_at | MMP9 | Hs.151738 | matrix metalloproteinase 9 (gelatinase B, |
| | | | 92 kDa gelatinase, 92 kDa type IV |
| | | | collagenase) |
| 203964_at | NMI | Hs.54483 | N-myc (and STAT) interactor |
| 204006_s_at | FCGR3A | Hs.372679 | Fc fragment of IgG, low affinity IIIa, |
| | | | receptor for (CD16) |
| 204007_at | FCGR3A | Hs.372679 | Fc fragment of IgG, low affinity IIIa, |
| | | | receptor for (CD16) |
| 204070_at | RARRES3 | Hs.17466 | retinoic acid receptor responder (tazarotene |
| | | | induced) 3 |
| 204162_at | HEC | Hs.414407 | highly expressed in cancer, rich in leucine |
| | | | heptad repeats |
| 204205_at | APOBEC3G | Hs.286849 | apolipoprotein B mRNA editing enzyme, |
| | | | catalytic polypeptide-like 3G |
| 204269_at | PIM2 | Hs.80205 | pim-2 oncogene |
| 204279_at | PSMB9 | Hs.381081 | proteasome (prosome, macropain) subunit, |
| | | | beta type, 9 (large multifunctional protease |
| | | | 2) |
| 204430_s_at | SLC2A5 | Hs.33084 | solute carrier family 2 (facilitated |
| | | | glucose/fructose transporter), member 5 |
| 204446_s_at | ALOX5 | Hs.89499 | arachidonate 5-lipoxygenase |
| 204655_at | CCL5 | Hs.489044 | chemokine (C-C motif) ligand 5 |
| 204774_at | EVI2A | Hs.70499 | ecotropic viral integration site 2A |
| 204820_s_at | BTN3A3 | Hs.167741 | butyrophilin, subfamily 3, member A3 |
| 204821_at | BTN3A3 | Hs.167741 | butyrophilin, subfamily 3, member A3 |
| 204861_s_at | BIRC1 | Hs.79019 | baculoviral IAP repeat-containing 1 |
| 205098_at | CCR1 | Hs.301921 | chemokine (C-C motif) receptor 1 |
| 205099_s_at | CCR1 | Hs.301921 | chemokine (C-C motif) receptor 1 |
| 205159_at | CSF2RB | Hs.285401 | colony stimulating factor 2 receptor, beta, |
| | | | low-affinity (granulocyte-macrophage) |
| 205269_at | LCP2 | Hs.2488 | lymphocyte cytosolic protein 2 (SH2 |
| | | | domain containing leukocyte protein of |
| | | | 76 kDa) |
| 205488_at | GZMA | Hs.90708 | granzyme A (granzyme 1, cytotoxic T- |
| | | | lymphocyte-associated serine esterase 3) |
| 205552_s_at | OAS1 | Hs.442936 | 2′,5′-oligoadenylate synthetase 1, 40/46 kDa |
| 205786_s_at | ITGAM | Hs.172631 | integrin, alpha M (complement component |
| | | | receptor 3, alpha; also known as CD11b |
| | | | (p170), macrophage antigen alpha |
| | | | polypeptide) |
| 205841_at | JAK2 | Hs.434374 | Janus kinase 2 (a protein tyrosine kinase) |
| 206150_at | TNFRSF7 | Hs.355307 | tumor necrosis factor receptor superfamily, |
| | | | member 7 |
| 206370_at | PIK3CG | Hs.32942 | phosphoinositide-3-kinase, catalytic, |
| | | | gamma polypeptide |
| 206545_at | CD28 | Hs.1987 | CD28 antigen (Tp44) |
| 206584_at | LY96 | Hs.69328 | lymphocyte antigen 96 |
| 206666_at | GZMK | Hs.277937 | granzyme K (serine protease, granzyme 3; |
| | | | tryptase II) |
| 206914_at | CRTAM | Hs.159523 | class-I MHC-restricted T cell associated |
| | | | molecule |
| 206991_s_at | CCR5 | Hs.511796 | chemokine (C-C motif) receptor 5 |
| 208146_s_at | CPVL | Hs.95594 | carboxypeptidase, vitellogenic-like |
| 208442_s_at | ATM | Hs.504644 | ataxia telangiectasia mutated (includes |
| | | | complementation groups A, C and D) |
| 208771_s_at | LTA4H | Hs.81118 | leukotriene A4 hydrolase |
| 208997_s_at | UCP2 | Hs.80658 | uncoupling protein 2 (mitochondrial, proton |
| | | | carrier) |
| 208998_at | UCP2 | Hs.80658 | uncoupling protein 2 (mitochondrial, proton |
| | | | carrier) |
| 209040_s_at | PSMB8 | Hs.180062 | proteasome (prosome, macropain) subunit, |
| | | | beta type, 8 (large multifunctional protease |
| | | | 7) |
| 209474_s_at | ENTPD1 | Hs.444105 | ectonucleoside triphosphate |
| | | | diphosphohydrolase 1 |
| 209480_at | HLA-DQB1 | Hs.409934 | major histocompatibility complex, class II, |
| | | | DQ beta 1 |
| 209606_at | PSCDBP | Hs.270 | pleckstrin homology, Sec7 and coiled-coil |
| | | | domains, binding protein |
| 209728_at | HLA-DRB3 | Hs.308026 | major histocompatibility complex, class II, |
| | | | DR beta 3 |
| 209734_at | HEM1 | Hs.443845 | hematopoietic protein 1 |
| 209748_at | SPG4 | Hs.512701 | spastic paraplegia 4 (autosomal dominant; |
| | | | spastin) |
| 209823_x_at | HLA-DQB1 | Hs.409934 | major histocompatibility complex, class II, |
| | | | DQ beta 1 |
| 209846_s_at | BTN3A2 | Hs.376046 | butyrophilin, subfamily 3, member A2 |
| 209969_s_at | STAT1 | Hs.21486 | signal transducer and activator of |
| | | | transcription 1, 91 kDa |
| 210046_s_at | IDH2 | Hs.5337 | isocitrate dehydrogenase 2 (NADP+), |
| | | | mitochondrial |
| 210154_at | ME2 | Hs.75342 | malic enzyme 2, NAD(+)-dependent, |
| | | | mitochondrial |
| 210164_at | GZMB | Hs.1051 | granzyme B (granzyme 2, cytotoxic T- |
| | | | lymphocyte-associated serine esterase 1) |
| 210220_at | FZD2 | Hs.142912 | frizzled homolog 2 (Drosophila) |
| 210538_s_at | BIRC3 | Hs.127799 | baculoviral IAP repeat-containing 3 |
| 210982_s_at | HLA-DRA | Hs.409805 | major histocompatibility complex, class II, |
| | | | DR alpha |
| 211336_x_at | LILRB1 | Hs.149924 | leukocyte immunoglobulin-like receptor, |
| | | | subfamily B (with TM and ITIM domains), |
| | | | member 1 |
| 212415_at | Sep 06 | Hs.90998 | septin 6 |
| 212543_at | AIM1 | Hs.422550 | absent in melanoma 1 |
| 212588_at | PTPRC | Hs.444324 | protein tyrosine phosphatase, receptor type, C |
| 212998_x_at | HLA-DQB2 | Hs.375115 | major histocompatibility complex, class II, |
| | | | DQ beta 2 |
| 212999_x_at | HLA-DQB1 | Hs.409934 | major histocompatibility complex, class II, |
| | | | DQ beta 1 |
| 213160_at | DOCK2 | Hs.17211 | dedicator of cyto-kinesis 2 |
| 213174_at | KIAA0227 | Hs.79170 | KIAA0227 protein |
| 213241_at | PLXNC1 | Hs.286229 | plexin C1 |
| 213452_at | ZNF184 | Hs.158174 | zinc finger protein 184 (Kruppel-like) |
| 213618_at | CENTD1 | Hs.427719 | centaurin, delta 1 |
| 213831_at | HLA-DQA1 | Hs.387679 | major histocompatibility complex, class II, |
| | | | DQ alpha 1 |
| 214054_at | DOK2 | Hs.71215 | docking protein 2, 56 kDa |
| 214218_s_at | — | Hs.83623 | Homo sapiens cDNA: FLJ21545 fis, clone |
| | | | COL06195 |
| 214370_at | S100A8 | Hs.416073 | S100 calcium binding protein A8 |
| | | | (calgranulin A) |
| 214511_x_at | FCGR1A | Hs.77424 | Fc fragment of IgG, high affinity Ia, |
| | | | receptor for (CD64) |
| 216950_s_at | FCGR1A | Hs.77424 | Fc fragment of IgG, high affinity Ia, |
| | | | receptor for (CD64) |
| 217028_at | CXCR4 | Hs.421986 | chemokine (C—X—C motif) receptor 4 |
| 217983_s_at | RNASE6PL | Hs.388130 | ribonuclease 6 precursor |
| 218035_s_at | FLJ20273 | Hs.95549 | RNA-binding protein |
| 218404_at | SNX10 | Hs.418132 | sorting nexin 10 |
| 218747_s_at | TAPBP-R | Hs.267993 | TAP binding protein related |
| 218979_at | FLJ12888 | Hs.284137 | hypothetical protein FLJ12888 |
| 219546_at | BMP2K | Hs.20137 | BMP2 inducible kinase |
| 219551_at | EAF2 | Hs.383018 | ELL associated factor 2 |
| 219666_at | MS4A6A | Hs.371612 | membrane-spanning 4-domains, subfamily |
| | | | A, member 6A |
| 219694_at | FLJ11127 | Hs.155085 | hypothetical protein FLJ11127 |
| 219759_at | LRAP | Hs.374490 | leukocyte-derived arginine aminopeptidase |
| 219777_at | hIAN2 | Hs.105468 | human immune associated nucleotide 2 |
| 219872_at | DKFZp434L142 | Hs.323583 | hypothetical protein DKFZp434L142 |
| 219956_at | GALNT6 | Hs.20726 | UDP-N-acetyl-alpha-D- |
| | | | galactosamine:polypeptide N- |
| | | | acetylgalactosaminyltransferase 6 |
| | | | (GalNAc-T6) |
| 220330_s_at | SAMSN1 | Hs.221851 | SAM domain, SH3 domain and nuclear |
| | | | localisation signals, 1 |
| 221210_s_at | NPL | Hs.64896 | N-acetylneuraminate pyruvate lyase |
| | | | (dihydrodipicolinate synthase) |
| 221658_s_at | IL21R | Hs.210546 | interleukin 21 receptor |
| 221698_s_at | CLECSF12 | Hs.161786 | C-type (calcium dependent, carbohydrate- |
| | | | recognition domain) lectin, superfamily |
| | | | member 12 |
| 221728_x_at | — | Hs.83623 | Homo sapiens cDNA: FLJ21545 fis, clone |
| | | | COL06195 |
| 221879_at | CLN6 | Hs.43654 | ceroid-lipofuscinosis, neuronal 6, late |
| | | | infantile, variant |
| 38241_at | BTN3A3 | Hs.167741 | butyrophilin, subfamily 3, member A3 |

TABLE 8
Selected Genes of Tables 6 and 7, which are suitable for distinguishing
two subgroups of rheumatoid arthritis. The genes exhibit different levels
of activity between the two RA subgroups in the t-test analysis with a
significance of p ≦ 0.05 and are used as a basis for FIG. 9.

| Affymetrix_ID | Gen Symbol | Unigene | Name |
|---|---|---|---|
| 200887_s_at | STAT1 | Hs.21486 | signal transducer and activator of |
| | | | transcription 1, 91 kDa |
| 201310_s_at | C5orf13 | Hs.508741 | chromosome 5 open reading frame 13 |
| 201422_at | IFI30 | Hs.14623 | interferon, gamma-inducible protein 30 |
| 201850_at | CAPG | Hs.82422 | capping protein (actin filament), gelsolin- |
| | | | like |
| 203915_at | CXCL9 | Hs.77367 | chemokine (C—X—C motif) ligand 9 |
| 203964_at | NMI | Hs.54483 | N-myc (and STAT) interactor |
| 204051_s_at | SFRP4 | Hs.105700 | secreted frizzled-related protein 4 |
| 204114_at | NID2 | Hs.147697 | nidogen 2 (osteonidogen) |
| 204279_at | PSMB9 | Hs.381081 | proteasome (prosome, macropain) subunit, |
| | | | beta type, 9 (large multifunctional protease |
| | | | 2) |
| 204358_s_at | FLRT2 | Hs.48998 | fibronectin leucine rich transmembrane |
| | | | protein 2 |
| 204359_at | FLRT2 | Hs.48998 | fibronectin leucine rich transmembrane |
| | | | protein 2 |
| 204475_at | MMP1 | Hs.83169 | matrix metalloproteinase 1 (interstitial |
| | | | collagenase) |
| 205049_s_at | CD79A | Hs.79630 | CD79A antigen (immunoglobulin- |
| | | | associated alpha) |
| 205234_at | SLC16A4 | Hs.351306 | solute carrier family 16 (monocarboxylic |
| | | | acid transporters), member 4 |
| 205242_at | CXC L13 | Hs.100431 | chemokine (C—X—C motif) ligand 13 (B- |
| | | | cell chemoattractant) |
| 205267_at | POU2AF1 | Hs.2407 | POU domain, class 2, associating factor 1 |
| 205488_at | GZMA | Hs.90708 | granzyme A (granzyme 1, cytotoxic T- |
| | | | lymphocyte-associated serine esterase 3) |
| 205671_s_at | HLA-DOB | Hs.1802 | major histocompatibility complex, class II, |
| | | | DO beta |
| 205692_s_at | CD38 | Hs.174944 | CD38 antigen (p45) |
| 205828_at | MMP3 | Hs.375129 | matrix metalloproteinase 3 (stromelysin 1, |
| | | | progelatinase) |
| 205890_s_at | UBD | Hs.44532 | ubiquitin D |
| 206025_s_at | TNFAIP6 | Hs.407546 | tumor necrosis factor, alpha-induced |
| | | | protein 6 |
| 206026_s_at | TNFAIP6 | Hs.407546 | tumor necrosis factor, alpha-induced |
| | | | protein 6 |
| 206336_at | CXCL6 | Hs.164021 | chemokine (C—X—C motif) ligand 6 |
| | | | (granulocyte chemotactic protein 2) |
| 206545_at | CD28 | Hs.1987 | CD28 antigen (Tp44) |
| 206641_at | TNFRSF17 | Hs.2556 | tumor necrosis factor receptor superfamily, |
| | | | member 17 |
| 207173_x_at | CDH11 | Hs.443435 | cadherin 11, type 2, OB-cadherin |
| | | | (osteoblast) |
| 208146_s_at | CPVL | Hs.95594 | carboxypeptidase, vitellogenic-like |
| 209040_s_at | PSMB8 | Hs.180062 | proteasome (prosome, macropain) subunit, |
| | | | beta type, 8 (large multifunctional protease |
| | | | 7) |
| 209546_s_at | APOL1 | Hs.114309 | apolipoprotein L, 1 |
| 209748_at | SPG4 | Hs.512701 | spastic paraplegia 4 (autosomal dominant; |
| | | | spastin) |
| 209875_s_at | SPP1 | Hs.313 | secreted phosphoprotein 1 (osteopontin, |
| | | | bone sialoprotein I, early T-lymphocyte |
| | | | activation 1) |
| 210643_at | TNFSF11 | Hs.333791 | tumor necrosis factor (ligand) superfamily, |
| | | | member 11 |
| 212651_at | RHOBTB1 | Hs.15099 | Rho-related BTB domain containing 1 |
| 212671_s_at | HLA-DQA1 | Hs.387679 | major histocompatibility complex, class II, |
| | | | DQ alpha 1 |
| 215536_at | HLA-DQB2 | Hs.375115 | major histocompatibility complex, class II, |
| | | | DQ beta 2 |
| 217362_x_at | HLA-DRB3 | Hs.308026 | major histocompatibility complex, class II, |
| | | | DR beta 3 |
| 217388_s_at | KYNU | Hs.444471 | kynureninase (L-kynurenine hydrolase) |
| 217430_x_at | — | Hs.172928 | Homo sapiens mRNA for chimaeric |
| | | | transcript of collagen type 1 alpha 1 and |
| | | | platelet-derived growth factor beta, 189 bp. |
| 217478_s_at | HLA-DMA | Hs.351279 | major histocompatibility complex, class II, |
| | | | DM alpha |
| 219386_s_at | BLAME | Hs.438683 | B lymphocyte activator macrophage |
| | | | expressed |
| 222288_at | — | Hs.130526 | Homo sapiens transcribed sequence with |
| | | | weak similarity to protein ref: NP_060312.1 |
| | | | (H. sapiens) hypothetical protein FLJ20489 |
| | | | [Homo sapiens] |

### GLOSSARY

Genome The complete DNA sequence of a set of chromosomes
Transcriptome The complete set of RNA transcripts, which were read at a specific time of the genome
Proteome The complete set of proteins, which was produced and modified after the transcription
Gene Expression Profile Pattern of the transcription level of genes in a given sample
Gene Expression Signature Profiles that were induced by a defined condition or are associated with a state (e.g., the profile of a certain cell type in the normal state; or the cytokine-induced profile in a tissue or cell type)
Normal State Healthy state that is not influenced by disease
Marker Gene Gene that is characteristic of a signature and, based on its expression strength, the proportion of the signature in a complex sample can be determined
Molecular Profile A pattern of signal strengths that consist of various representatives of a molecular substance class in a given sample.

### Clarification of the Variables Used in the Equations

y Signal
x Concentration
S1 Maximum measured signal over all genes in all arrays that were included (here, 123 arrays)
K1 RNA concentration assumed for signal S1
S0 Minimum signal measured and still classified as “present” over all genes in all arrays that were included (here, 123 arrays)
K0 RNA concentration assumed for signal S0
S Cell Type Signal of a gene, which is measured by a cell type purified from the normal state
K Cell Type RNA concentration of a gene corresponding to the S cell-type signal
A Cell Type Proportion of a defined cell population in a complex sample that consists of various cell types
Ki RNA concentration of a gene in the normal state corresponding to the cell type i
Ai or AP,i Proportion of the cell population i in a complex sample that consists of various cell types
AK,i Proportion of the cell population i in a complex control that consists of various cell types
S Sample Signal of a gene that is measured by a complex sample that is to be examined
K Sample RNA concentration of a gene corresponding to the S sample signal
S Control Signal of a gene that is measured by a defined control sample (normal state)
K Control RNA concentration of a gene corresponding to the S control signal
Sₘᵢₙ Signal that is measured as a detection limit for a gene
Kmin RNA concentration of a gene corresponding to the Smin signal
SminI Signal that is measured at a detection limit that is ideal for the measuring system
KminI RNA concentration of a gene corresponding to the SminI signal
SminG Signal that is measured under disadvantageous conditions as a detection limit for a gene
KminG RNA concentration of a gene corresponding to the SminG signal
KminM1 RNA concentration of a gene corresponding to the SminG signal that results if model M1 is assumed
KminM2 RNA concentration of a gene corresponding to the SminG signal that results if model M2 is assumed
K Sample M1 Concentration of a sample assuming model M1
K Sample M2 Concentration of a sample assuming model M2
S′ Sample Signal of a gene in a complex sample, which is calculated virtually from the signatures
K′ Sample Concentration of a gene in a complex sample, which is calculated virtually from the signatures
AResidue Residual portion in a complex sample that remains after all portions belonging to the known signatures are subtracted
KResidue Concentration of a gene in the residual population in the normal state
KF Correction factor for matching the signature concentrations to a complex control
Ki,reg Change in concentration of a gene that is produced by regulation in comparison to the normal state
Ki,f Concentration of a gene in the cell type i under a functional influence
SLR Signal Log Ratio

1. Process for quantitative determination and qualitative characterization of a complex expression profile in a biological sample, comprising the steps of
a) Making available a biological sample to be examined,
b) Making available at least one expression profile that is characteristic of an influence and thus defined, that is contained or is sought in the sample to be examined, whereby at least one defined expression profile comprises one or more markers that are typical exclusively of the expression profile,
c) Determining the complex expression profile of the biological sample, and
d) Quantitative determination of the proportion of any defined expression profile made available in step b) based on the proportion of typical markers in the expression profile of the biological sample determined in step c).

2. Process for quantitative determination and qualitative characterization of a complex expression profile in a biological sample, comprising the additional steps of
e) Calculation of a virtual profile of signals, which is expected because of the proportions of the known characteristic expression profiles,
f) Calculation of the difference between the actually measured complex expression profile and the virtual profile, such that a residual profile is produced, and
g) Determination of other typical features of the sample from the residual profile by the comparison with residual profiles of other complex samples.

3. Process for quantitative determination and qualitative characterization of a complex expression profile in a biological sample according to claim 1 whereby the determination of the suitable expression profile comprises the determination of an RNA expression profile, protein-expression profile, protein-secretion profile, DNA methylation profile and/or metabolite profile.

4. Process for quantitative determination and qualitative characterization of a complex expression profile in a biological sample according to claim 1, whereby the determination of an expression profile comprises a molecular detection method, such as, e.g., a gene array, protein array, peptide array and/or PCR array, a mass spectrometry or the generation of a differential blood picture or a FACS analysis.

5. Process for quantitative determination and qualitative characterization of a complex expression profile in a biological sample according to claim 1, whereby the expression profiles determined in step b) are selected from the group of expression profiles that characterize functional influences or conditions, such as, e.g., expression profiles that characterize the activity of certain messenger substances, the signal transduction or the gene regulation, or characterize the manifestation of certain molecular processes, such as, e.g., apoptosis, cell division, cell differentiation, tissue development, inflammation, infection, tumor genesis, metastasizing, formation of new vessels, invasion, destruction, regeneration, autoimmune reaction, immunocompatibility, wound healing, allergy, poisoning, or sepsis, or characterize the clinical conditions that are specific to the manifestation, such as, e.g., the state of the disease or the action of medications.

6. Process for quantitative determination and qualitative characterization of a complex expression profile in a biological sample according to claim 1, whereby the calculation of the overall concentration is carried out from the proportions Aᵢ of the various cell types or influences i with their varying concentrations Kᵢ by means of the relationship
$${K}_{Sample} = {K}_{1} \cdot {A}_{1} + {K}_{2} \cdot {A}_{2} + … = {\sum }_{i = 1}^{n} ( {K}_{i} \cdot {A}_{i} ) with i ∈ N \qquad ( Equation 3 )$$

7. Process for quantitative determination and qualitative characterization of a complex expression profile in a biological sample according to claim 1, whereby the proportion of a marker gene is determined by means of the formula
$${A}_{CellType} = \frac{{K}_{Sample}}{{K}_{CellType}}$$
or for a double-logarithmic relationship of concentration and signal
$${A}_{CellType} = {2}^{\frac{1}{k} ( {SLR}_{Sample / Control} - {SLR}_{CellType / Control} )} \qquad ( Equation 11 or 14 )$$
whereby “cell type” is representative of a characteristically defined expression profile.

8. Process for quantitative determination and qualitative characterization of a complex expression profile in a biological sample according to claim 1, whereby for the determination of the proportions of monocytes, T cells or granulocytes of the markers, a selection is made from the markers indicated in Table 2.

9. Process for quantitative determination and qualitative characterization of a complex expression profile in a biological sample according to claim 1, comprising the qualitative and/or quantitative detection of expression profiles of a cell type that is present in inflammation processes, in particular the T cells, B cells, monocytes, macrophages, granulocytes, natural killer cells (NK cells), and dendritic cells.

10. Process for quantitative determination and qualitative characterization of a complex expression profile in a biological sample according to claim 1, whereby the determination of the quantitative composition of the complex expression profile based on the determined differences between virtual and actual expression profiles in addition comprises the identification of a previously unknown expression profile.

11. Process for quantitative determination and qualitative characterization of a complex expression profile in a biological sample according to claim 1, whereby the determination of the quantitative composition of the complex expression profile based on the determined differences between virtual and actual expression profiles in addition comprises the identification of molecular candidates for the diagnostic, prognostic and/or therapeutic application.

12. Process for diagnosis, prognosis and/or tracking of a disease that comprises a process according to claim 1.

13. Computer system that is provided with means for implementing the process according to claim 1.

14. Computer program comprising a programming code to execute the steps of the process according to claim 1 if carried out in a computer.

15. Computer-readable data medium comprising a computer program according to claim 14 in the form of a computer-readable programming code.

16. Laboratory robot or evaluating device for molecular detection methods, comprising a computer system and/or a computer program according to claim 13.

17. Molecular candidate for the diagnostic, prognostic and/or therapeutic application, identified according to claim 1.

18. Molecular candidate for the diagnostic, prognostic, and/or therapeutic application according to claim 17, which has a sequence cited in one of Tables 5 to 8.

19. Use of a molecular candidate according to claim 17
a) For characterization of the inflammatory cell infiltration into an inflamed tissue with genes of Table 5 differentiating from the gene activation by inflammation,
b) For characterization of the gene activation in an inflamed tissue with genes of Table 6 differentiating from the cell infiltration,
c) For characterization of the gene activation or the inflammatory cell infiltration into an inflamed tissue via the calculated portion of activation or infiltration of genes in Table 7,
d) For characterization of subgroups of inflammatory gene activation with genes of Tables 6, 7 and/or 8.

20. Use of a molecular candidate according to claim 17 for screening pharmacologically active substances, in particular binding partners.
